(19) United States
(12) Patent Application Publication
(10) Pub. No.: US 2014/0020790 A1
(43) Pub. Date: Jan. 23, 2014

(54) CO-INFUSION APPARATUS

(71) Applicants: Hiroyuki Yuyama, Toyonaka-shi (JP); Akifumi Tanaka, Toyonaka-shi (JP); Kazuki Kawauchi, Toyonaka-shi (JP)

(72) Inventors: Hiroyuki Yuyama, Toyonaka-shi (JP); Akifumi Tanaka, Toyonaka-shi (JP); Kazuki Kawauchi, Toyonaka-shi (JP)

(73) Assignee: YUYAMA MFG. CO., LTD., Toyonaka-shi, Osaka (JP)

(21) Appl. No.: 14/007,320

(22) PCT Filed: Mar. 21, 2012
(86) PCT No.: PCT/JP2012/057201

§ 371 Date: Sep. 24, 2013

(30) Foreign Application Priority Data
Mar. 25, 2011 (JP) 2011-066973
Jun. 6, 2011 (JP) 2011-126236
Sep. 29, 2011 (JP) 2011-215204

(51) Int. Cl. A61J 1/20

(52) U.S. Cl. CPC A61J 1/2096
USPC 141/27

(57) ABSTRACT

A co-infusion apparatus is provided to prevent foaming of a transfusion when the transfusion is introduced into a medicine container, and to prevent the transfusion from directly hitting a medicine inside a vial. The co-infusion apparatus includes: a container holding section for holding a medicine container and tilting the medicine container; a syringe holding section for holding a syringe, tilting the syringe, and varying an amount of insertion of a plunger of the syringe into a barrel of the syringe: and an insertion operation section for inserting a needle of the syringe through a mouth of the medicine container which is held by the container holding section, and inserting the needle of the syringe through a mixing port of a transfusion bag.

This application is a national phase entry under 35 U.S.C. §371 of International Application No. PCT/JP2012/057201, filed on Mar. 21, 2012, and claims priority under 35 U.S.C. §119 to Japanese Patent Application No. JP2011-215204, filed on Sep. 29, 2011, Japanese Patent Application No. JP2011-126236, filed on Jun. 6, 2011, and Japanese Patent Application No. JP2011-066973, filed on Mar. 25, 2011, the contents of which are hereby incorporated by reference in their entirety for all purposes.

### TECHNICAL FIELD

The present invention relates to a co-infusion apparatus for mixing a medicine such as an anticancer drug with a transfusion (fluid replacement).

### BACKGROUND OF THE INVENTION

Some medicines such as anticancer drugs are normally used in a mixture with a transfusion, but pose a risk of exposure to anticancer drugs for example. When such a medicine is mixed with a transfusion, the mixing operation is carried out in a safety cabinet which is a space maintained at a negative pressure. With the above, when a mixing operation is performed by using a vial which sealingly contains a medicine in the form of powder as the medicine mentioned above, the person who performs the mixing operation uses a syringe to take some transfusion from the transfusion bag, then insert the needle of the syringe through a cap (rubber closure) of the vial, and then infuses the transfusion which is held inside the syringe into the vial. Then, the medicine mixing operator sucks the transfusion, in which the medicine is now dissolved, into the syringe. The vial sealingly contains a predetermined amount of medicine. Therefore, the medicine mixing operator repeats this cycle of introducing transfusion into the vial and then sucking the transfusion, until a required amount of medicine has been dissolved in the transfusion. After the required amount of medicine has been dissolved in the transfusion, the medicine mixing operator inserts the needle of the syringe into a mixing port of the transfusion bag and returns the transfusion, which contains the medicine as a solution, from the syringe back into the transfusion bag.

Other than vials described above, ampoules may also be used as a container of a liquid medicine which must be mixed with the transfusion in the mixing operation. When an ampoule is involved in the mixing operation, a tip of the ampoule is cut off, and the liquid medicine inside the ampoule is then drawn into the syringe, and then the needle of the syringe is inserted into the mixing port of the transfusion bag, to inject the liquid medicine from inside the syringe into the transfusion bag.

With these backgrounds, Japanese Patent literature JP-A H1-244759 Gazette (hereinafter Patent Literature 1) discloses a radioactive medicine dispensing device which performs dispensing operation while avoiding the risk of exposure to radioactivity from radioactive medicines. The radioactive medicine dispensing device includes syringe holding means for holding a syringe; a first lifting means for moving the syringe holding means in up and down directions; plunger holding means for holding a plunger of the syringe; a second lifting means for moving the plunger in up and down directions; and a rotation mechanism which rotates the syringe holding means, the first lifting means, the plunger holding means and the second lifting means to a halfway around.

This leads to an idea of performing the above-described mixing operation by a machine, utilizing the radioactive medicine dispensing device disclosed in Patent Literature 1.

However, the radioactive medicine dispensing device in Patent Literature 1 cannot change the attitude of the container or mixing container, and this poses a problem when using such a radioactive medicine dispensing device. Take, for example, a case where a transfusion bag is used as the container which is disposed at an upper position of the device, and a vial is used as a mixing container which is disposed at a lower position of the device. When the needle of the syringe is inserted into the cap of the vial to infuse the transfusion from inside the syringe into the vial, the vial is held upright, so the transfusion will directly hit the powdery medicine at the bottom of the vial. Specifically, it is not possible to let the transfusion flow along the inner wall surface of the vial. This causes such problems as foaming of the transfusion, and the medicine inside the vial being hit directly by the transfusion.

Also, when the container of the medicine is provided by an ampoule, it is desirable that the needle of the syringe does not make contact with the bottom of the ampoule because fine broken pieces of the ampoule might have fallen into the ampoule when a tip of the ampoule was cut. Yet, the sucking of the liquid medicine must be made completely to the extent that there is little amount left in the ampoule. However, it is difficult for the radioactive medicine dispensing device in Patent Literature 1 to do such a sucking operation.

An object of the present invention is to prevent foaming of a transfusion when the transfusion is infused to the medicine container, and to prevent the transfusion from directly hitting the medicine inside the vial, in a co-infusion apparatus. Another object is to make it possible, when the medicine container is provided by an ampoule, to suck the liquid medicine with a least amount left without allowing the tip of the syringe needle to make contact with the bottom of the ampoule.

### SUMMARY OF THE INVENTION

In order to solve the problems described above, the present invention provides a co-infusion apparatus which includes: a container holding section for holding a medicine container and tilting the medicine container; a syringe holding section for holding a syringe, tilting the syringe, and varying an amount of insertion of a plunger of the syringe into a barrel of the syringe: and an insertion operation section for inserting a needle of the syringe through a mouth of the medicine container which is held by the container holding section, and inserting the needle of the syringe through a mixing port of a transfusion bag.

The configuration described above provides the following benefits when the medicine container is provided by a vial for example: As the needle of the syringe is inserted into the vial and then the medicine container and the syringe are tilted by, e.g., the same angle, the tip of the needle is still pointing the bottom of the vial, yet it is possible to position an inner wall surface of the vial to right below the tip of the needle. This enables to drip the transfusion onto the inner wall surface of the vial and thereby infuse the liquid gently along the inner wall surface to the bottom of the container when moving the transfusion from inside the syringe to inside the vial after the transfusion was taken from the transfusion bag. This prevents the transfusion from foaming or directly hitting the medicine inside the vial when putting the transfusion into the medicine container.

The co-infusion apparatus may further have the following arrangement: The container holding section and the syringe holding section are supported by a pivotable support so that pivoting the support causes the container holding section to tilt the medicine container, and the syringe holding section to tilt the syringe.

Alternatively, the co-infusion apparatus may further have the following arrangement: The syringe holding section is supported by a pivotable support so that pivoting the support causes the syringe holding section to tilt the syringe whereas the container holding section is movable along a curvy route to tilt the medicine container.

The co-infusion apparatus may further include a mechanism for individually pivoting the container holding section thereby further tilting the medicine container, in addition to the tilting of the medicine container by the support. Alternatively, the co-infusion apparatus may further include a mechanism for individually pivoting the container holding section thereby further tilting the medicine container, in addition to the tilting of the medicine container by the movement along the curvy route.

The co-infusion apparatus may further have the following arrangement: The syringe holding section is supported by a pivotable support so that pivoting the support causes the syringe holding section to tilt the syringe whereas the container holding section is linearly movable in a horizontal or an oblique direction. With this arrangement, the apparatus further includes a mechanism for individually pivoting the container holding section to tilt the medicine container.

The co-infusion apparatus may further include a mechanism for individually pivoting the container holding section to tilt the medicine container.

With the mechanism for individually turning the container holding section to tilt the medicine container, the co-infusion apparatus can bring the needle tip of the syringe to point an inner wall surface of the vial instead of pointing the bottom of the vial. The arrangement further ensures that the transfusion is infused gently along the inner wall surface of the vial. In cases where the medicine container is provided by an ampoule, the syringe is held at an angle while the ampoule is laid so that the liquid medicine will move to a neck region of the ampoule. Creating this state enables to suck the liquid medicine completely to an extent that there is little liquid medicine left, without allowing the needle of the syringe to touch the bottom of the ampoule.

In the co-infusion apparatus which includes the mechanism for individually pivoting the container holding section to tilt the medicine container, it is preferable that the medicine container which is held by the container holding section has its mouth positioned at a pivot center of the individual pivoting of the container holding section. The arrangement described above eliminates or reduces displacement in the position of the mouth of the medicine container relative to the position of the needle of the syringe when the container holding section is individually turned. Therefore, the invention prevents such a case that the needle of the syringe makes contact with the medicine container. Further, when the medicine container is provided by a vial, it is now possible to prevent a hole in a cap, which is made by the needle of the syringe that penetrates the cap, from being expanded in size due to the displacement change of the needle. Also, when the medicine container is provided by an ampoule, the arrangement enables more appropriate operation of sucking the liquid medicine completely without allowing the tip of the syringe needle to make contact with the bottom of the ampoule.

The co-infusion apparatus which includes the mechanism for individually pivoting the container holding section to tilt the medicine container may further include a mechanism for moving the container holding section so that moving the container holding section eliminates or reduces a positional change of the mouth of the medicine container relative to the needle caused by the individual pivoting of the container holding section. Alternatively, the container holding section may be moved linearly in a horizontal direction or an oblique direction so as to eliminate or reduce a positional change of the mouth of the medicine container relative to the needle caused by the individual pivoting of the container holding section. These arrangements are also capable of preventing a situation that the needle of the syringe makes contact with the medicine container.

Alternatively, the syringe holding section may be moved so as to eliminate or reduce a positional change of the mouth of the medicine container relative to the needle caused by the individual pivoting of the container holding section. The arrangement such as this is also capable of preventing a situation that the needle of the syringe makes contact with the medicine container.

In any of the co-infusion apparatuses described thus far, the syringe holding section which holds the syringe may include a blade member which is bitten into a barrel of the syringe when grasping the barrel. According to this arrangement, the blade is bitten into the barrel surface and therefore it is possible, without increasing the force to grasp the barrel, to prevent a situation that the barrel slips in the plunger moving direction when the plunger is moved in the syringe.

Any of the co-infusion apparatuses described thus far may have an arrangement that sucking of liquid medicine from inside the medicine container into the syringe includes a sequence of: moving the needle away from the liquid medicine; tilting the medicine container; placing the needle again into the liquid medicine followed by pushing the plunger; and then resuming an operation of pulling the plunger. According to this, if air has entered the needle of the syringe while the needle was unavoidably taken away from the liquid medicine temporarily at the time when tilting the medicine container, it is possible to discharge the air out of the needle through the above-described operation of putting the needle again in the liquid medicine and pushing the plunger.

Any of the co-infusion apparatuses described thus far may perform a plunger pulling operation to introduce air into the syringe and merge the air with an air bubble inside the syringe thereby creating a layer of air; and a plunger pushing operation to remove the layer of air. This removes the air bubble from the syringe, and allows accurate reading of the amount of liquid in the syringe.

Any of the co-infusion apparatuses described thus far may perform a plunger pulling operation to introduce air into the syringe and merge the air with an air bubble inside the syringe thereby creating a layer of air until the layer has a volume represented by one or a few scale marks indicated on the syringe. This allows accurate reading of the amount of liquid in the syringe while allowing a layer of air remaining in the syringe.

The present invention makes it possible to drip the transfusion on an inner wall surface of the vial thereby let the liquid flow down gently along the inner wall surface to the bottom. The present invention thus makes it possible, when putting the transfusion into the medicine container, to prevent the transfusion from foaming or directly hitting the medicine inside the vial. The present invention also provides an advantage of sucking liquid medicine completely with little amount left inside an ampoule, without allowing the needle of the syringe to touch the bottom of the ampoule.

### BRIEF DESCRIPTION OF THE DRAWINGS

The present disclosure is described in conjunction with the appended figures:

FIG. 1 is a perspective view which shows a co-infusion apparatus according to an embodiment of the present invention.

FIG. 2 is a perspective view which shows a mixing section of the co-infusion apparatus in FIG. 1.

FIG. 3 is a perspective view which shows how a vial is passed between the mixing section in FIG. 2 and a container holding section of the co-infusion apparatus in FIG. 1.

FIG. 4 is a perspective view which shows a co-infusion section in the co-infusion apparatus in FIG. 1.

FIG. 5 is a front view which shows a co-infusion section and a pivot tilter driving section in the co-infusion apparatus in FIG. 1.

FIG. 6 is a perspective view which shows a third moving section in the co-infusion apparatus in FIG. 1.

FIG. 7(A) and FIG. 7(B) are both front views which show a container tilting section in the third moving section.

FIG. 8 is a front view which shows the pivot tilter driving section in the co-infusion apparatus in FIG. 1.

FIG. 9 is a front view which shows the pivot tilter driving section, a transfusion bag holding section, a transfusion bag moving section and a transfusion bag tilting section in the co-infusion apparatus in FIG. 1.

FIG. 10 is an illustrative view which shows how the co-infusion section of the co-infusion apparatus in FIG. 1 works.

FIG. 11 is an illustrative view which shows how the co-infusion section and the transfusion bag holding section of the co-infusion apparatus in FIG. 1 work.

FIG. 12 is an illustrative view which shows how the co-infusion section and the transfusion bag holding section of the co-infusion apparatus in FIG. 1 work.

FIG. 13 is an illustrative view which shows how the co-infusion section of the co-infusion apparatus in FIG. 1 works.

FIG. 14 is an illustrative view which shows how the co-infusion section of the co-infusion apparatus in FIG. 1 works.

FIG. 15 is an illustrative view which shows how the co-infusion section of the co-infusion apparatus in FIG. 1 works.

FIG. 16 is an illustrative view which shows how the co-infusion section of the co-infusion apparatus in FIG. 1 works.

FIG. 17 is an illustrative view which shows how the co-infusion section of the co-infusion apparatus in FIG. 1 works.

FIG. 18 is an illustrative view which shows a syringe and a vial in a tilted state, and a linear movement thereof in the co-infusion apparatus in FIG. 1.

FIG. 19 is an illustrative view which shows a state where transfusion is being introduced from the syringe to the vial under the tilted state shown in FIG. 18.

FIG. 20 is an illustrative view which shows how the co-infusion section of the co-infusion apparatus in FIG. 1 works.

FIG. 21 is an illustrative view which shows how the co-infusion section of the co-infusion apparatus in FIG. 1 works.

FIG. 22 is an illustrative view which shows how the co-infusion section of the co-infusion apparatus in FIG. 1 works.

FIG. 23 is an illustrative view which shows how the co-infusion section of the co-infusion apparatus in FIG. 1 works.

FIG. 24 is an illustrative view which shows how the co-infusion section of the co-infusion apparatus in FIG. 1 works.

FIG. 25 is an illustrative view which shows how the co-infusion section of the co-infusion apparatus in FIG. 1 works.

FIG. 26 is an illustrative view which shows an ampoule being handled by the co-infusion apparatus in FIG. 1, and a state where a liquid medicine in the ampoule is being sucked by a syringe.

FIG. 27 is an illustrative view which shows a syringe and an ampoule in a tilted state, and a linear movement thereof in the co-infusion apparatus in FIG. 26.

FIG. 28 is a perspective view which shows a state where a vial on a container setting section has its mouth aligned with a pivot center of the container holding section, in the co-infusion apparatus shown in FIG. 1.

FIG. 29 is a perspective view which shows a co-infusion apparatus according to another embodiment of the present invention. The apparatus includes movable claws, and the figure shows a state where a vial has been moved in its height direction, to bring the mouth of the vial in alignment with a pivot center of the container holding section.

FIG. 30(A) and FIG. 30(B) are illustrative views which show a co-infusion apparatus according to still another embodiment of the present invention, where a third moving section is not supported by a support section but is capable of moving individually along a curved track.

FIG. 31(A) and FIG. 30(B) are illustrative views which show a co-infusion apparatus according to still another embodiment of the present invention, where a third moving section is not supported by a support section but is capable of making an individual linear movement.

FIG. 32 is a perspective view which shows an outside appearance of a co-infusion apparatus according to an embodiment of the present invention.

FIG. 33 is a perspective view which shows another example of syringe holding mechanism of the co-infusion apparatus in FIG. 1.

FIG. 34 is an illustrative view which shows an ampoule being handled by the co-infusion apparatus in FIG. 1. The figure shows an example operation where a liquid medicine in the ampoule is being sucked by a syringe.

FIG. 35(A) and FIG. 35(B) show relationships between a medicine container and an orientation of a cut-off surface at a tip of a needle of the syringe which is set in the co-infusion apparatus shown in FIG. 1.

FIG. 36 is an illustrative view which shows an example operation to deal with air bubble included when sucking a liquid medicine into a syringe that is set in the co-infusion apparatus shown in FIG. 1.

FIG. 37 is an illustrative view which shows an example operation to deal with air bubbles included when sucking a liquid medicine into a syringe that is set in the co-infusion apparatus shown in FIG. 1.

FIG. 38 shows holding claws of the transfusion bag holding section and a transfusion bag in the co-infusion apparatus shown in FIG. 1. FIG. 38 (A) is a plan view whereas FIG. 38 (B) is a side view.

FIG. 39 is an illustrative view which shows how the holding claws of the transfusion bag holding section in the co-infusion apparatus in FIG. 1 works.

### DETAILED DESCRIPTION OF THE INVENTION

Embodiments of the present invention will be described hereinafter with reference to the accompanying drawings, in which preferred exemplary embodiments of the invention are shown. The ensuing description is not intended to limit the scope, applicability or configuration of the disclosure. Rather, the ensuing description of the preferred exemplary embodiments will provide those skilled in the art with an enabling description for implementing preferred exemplary embodiments of the disclosure. It should be noted that this invention may be embodied in different forms without departing from the spirit and scope of the invention as set forth in the appended claims.

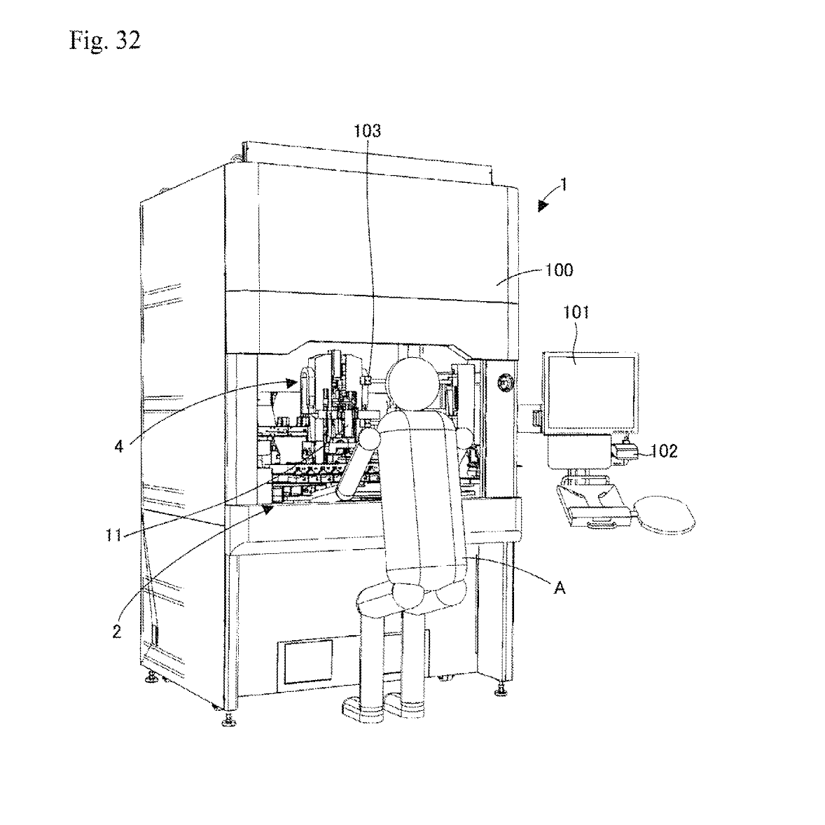

As shown in FIG. 32, a co-infusion apparatus 1 has its main body enclosed in a safety cabinet 100. A human operator A can open a window which covers an opening of the safety cabinet 100, and perform operations (e.g. placement of a vial(s) 10, a syringe 11 and a transfusion bag 12) in the main body. The safety cabinet 100 has a side wall, on an outside surface of which there are provided a display 101, a bar-code reader 102, etc. Upon using the apparatus, the operator A places a mixing instruction sheet over the bar-code reader 102, which then reads bar codes printed on the instruction sheet.

The co-infusion apparatus 1 has a controller, which reads out various information identified by the bar codes, including patient information, physician information, mixing operation programs, formulation information (type, quantity, etc. of the medicine to be used), preparation information (solute/solvent medicine, operation procedure, amount/dissolution amount, removal amount) from an unillustrated storage section. The mixing operation programs are selected based on the kind of medicine container (whether it is a vial or an ampoule). Also, the number of medicine containers to be used will determine the number of repetitions of a predetermined cycle of operations. Then, the controller displays the formulation information and preparation information on the display 101. The co-infusion apparatus 1 includes a moving camera 103 which is capable of taking images of the syringe and the medicine containers, and the images (audit images) taken by the moving camera 103 can also be shown on the display 101.

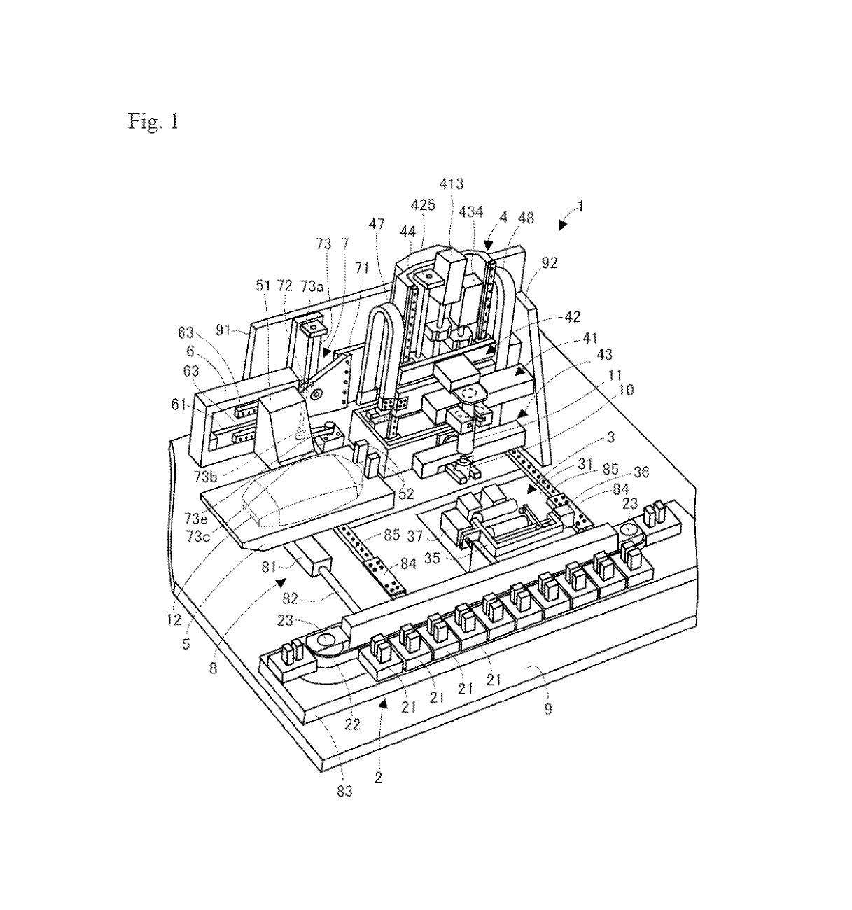

As shown in FIG. 1, the main body of the co-infusion apparatus 1 includes a carrier device 2 which carries medicine containers provided by vials 10; a mixing section 3 which shakes the vial 10; a co-infusion section 4 which performs operations to the vial 10 and the syringe 11; a transfusion bag holding section 5 which holds a transfusion bag 12; a transfusion bag moving section 6 which brings the transfusion bag holding section 5 closer to and away from the co-infusion section 4; a transfusion bag tilting section 7 which tilts the transfusion bag holding section 5 thereby tilting the transfusion bag moving section 6; a driving section 8 for bringing the carrier device 2 and the mixing section 3 closer to and away from the co-infusion section 4; and a base 9 on which the co-infusion section 4 and the driving section 8 are provided while the carrier device 2 and the mixing section 3 are movably supported.

On the base 9, a motor 81 is provided as a component of the driving section 8. The motor 81 has a rotating shaft connected with a feed screw 82 which is threaded into an unillustrated nut block provided under a movable table 83 supporting the carrier device 2 and the mixing section 3. A slider section 84 is fixed to the movable table 83. The slider section 84 is supported by guide rails 85 which are fixed on the base 9. As the motor 81 rotates the feed screw 82, the rotating force is converted into a linear moving force by the nut block. The movable table 83 receives the linear moving force and moves along the guide rails 85.

The carrier device 2 includes a plurality of container setting stands 21 for setting the vials 10. The container setting stands 21 are connected to a conveyer belt 22 and moved by the conveyer belt 22 to make a round trip. The conveyer belt 22 is wound around two pulleys 23. One of the pulleys 23 is driven by an unillustrated motor, whereby the conveyer belt 22 is driven. A vial 10 (or a plurality thereof) is set in one (or a plurality) of the container setting stands 21. When the container setting stand 21 carrying a vial 10 comes in front of the co-infusion section 4 for mixing operation, the movable table 83 makes a linear movement toward the co-infusion section 4 in order to pass the vial 10 to the co-infusion section 4.

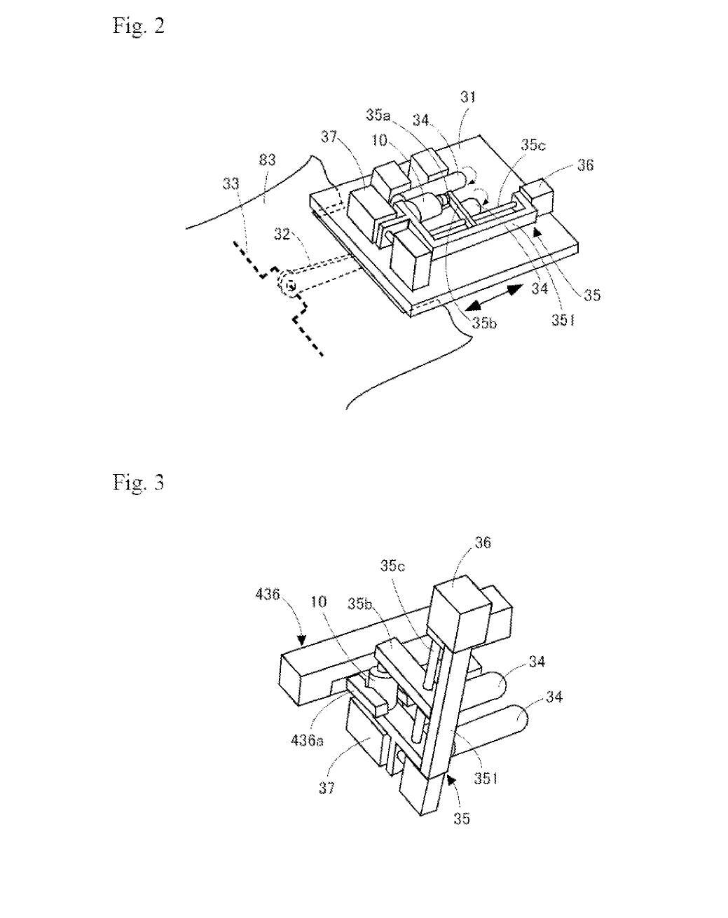

The mixing section 3 is at a lower height than the carrier device 2, and therefore, when the movable table 83 has moved toward the co-infusion section 4 and the vial 10 is passed to the co-infusion section 4, the mixing section 3 is under the co-infusion section 4. As shown in FIG. 2, the mixing section 3 includes a support table 31 which is separable from the movable table 83 for individual movement. On a lower surface of the support table 31, a tip end of a connecting rod 32 is fastened. The connecting rod 32 has a base end which is fastened to a crankshaft 33. As the crankshaft 33 is rotated by an unillustrated motor, the support table 31 makes a reciprocating movement in directions of arrows in the figure.

FIG. 2 shows a state where a vial 10 lies on a pair of rollers 34. When the rollers 34 are rotated in the same direction under this state, the vial 10 will be rotated. The vial 10 is supported at its bottom and cap (mouth) by rotation supports of a holder 35. The rotation support on the bottom side is provided on a main body 351 of the holder 35 whereas a rotation support 35a on the cap side is provided on a movable member 35b. The movable member 35b is screwed with a feed screw 35c, and as the feed screw 35c rotates, the movable member 35b makes a linear movement. The feed screw 35c has an upper end which is connected to a rotating shaft of a motor 36 provided at an upper end of the main body 351 of the holder 35. As the motor 36 is driven, the feed screw 35c is rotated. The holder 35 holds a vial 10 by holding the bottom and the cap of the vial 10 with its rotation supports. When placing the vial 10 on the pair of rollers 34, the holder 35 ceases its grasping action and releases the vial 10 to let it gravitationally make contact with surfaces of the rollers 34. After coming to this state, holding by the holder 35 is re-implemented.

As also shown in FIG. 3, the main body 351 of the holder 35 has its lower end connected to a rotating shaft of a motor 37, and as the motor 37 is driven, the holder 35 is pivoted. When the holder 35 is raised upright by this pivoting action, it is then possible to pass the vial 10 to/from a container holding section 436 of the co-infusion section 4. The holder 35 receives the vial 10 from the co-infusion section 4 after a transfusion has been introduced into this vial 10. The holder 35 passes the vial 10 to the co-infusion section 4 after the mixing section 3 has completed its shaking process (reciprocating action by the crankshaft 33 and rotating action by the rollers 34). When the vial 10 is passed in these occasions, the movable table 83 makes a linear travel.

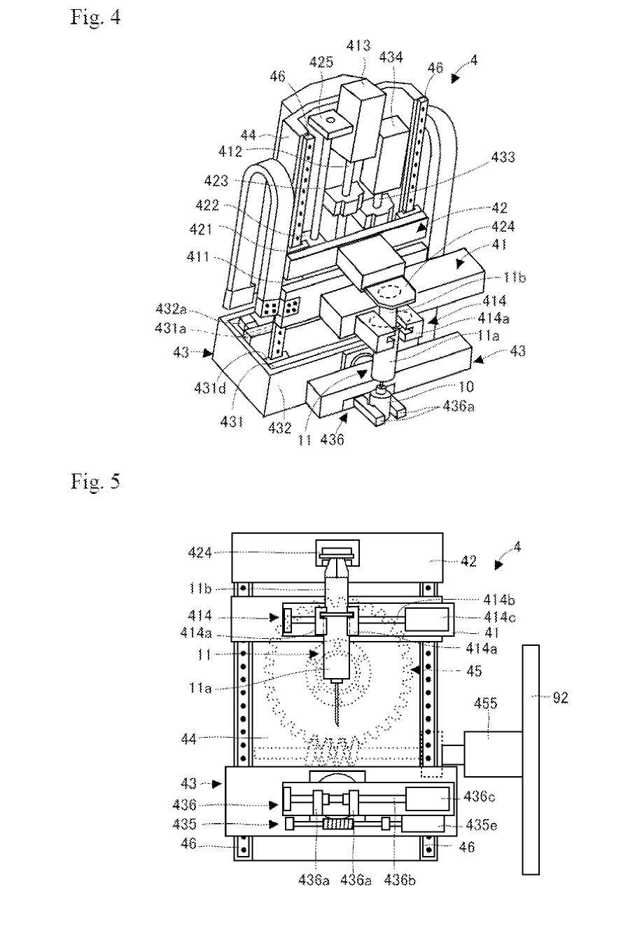

As shown in a perspective view in FIG. 4 and a front view in FIG. 5, the co-infusion section 4 includes: a first moving section 41 which holds a barrel 11a of the syringe 11 and moves the barrel 11a in a plunger-moving direction in the syringe 11; a second moving section 42 which holds an end of a plunger 11b of the syringe 11 and moves the plunger 11b in the plunger-moving direction; a third moving section 43 which moves the container holding section 436 that holds a vial 10, in the plunger-moving direction; a support 44 which supports the first moving section 41, the second moving section 42 and the third moving section 43; and a pivot tilter driving section which pivots the support 44 thereby tilting the plunger-moving direction off the gravitational direction (vertical direction). In the present embodiment, the first moving section 41, the second moving section 42 and the support 44 constitute the syringe holding section which holds the syringe 11, tilts the syringe 11, and varies the amount of insertion of the plunger 11b into the barrel 11a in the syringe.

The first moving section 41 is guided in the plunger-moving direction by a slider 411 which is engaged with a pair of guide rails 46 fixed to the support 44. On a back side of a main body of the first moving section 41, an unillustrated nut block is fixed. The nut block is screwed with a feed screw 412. The feed screw 412 has its one end supported rotatably at a bottom of the support 44 whereas its another end is connected to a rotating shaft of a motor 413 which is fixed on a wall surface of the support 44. As the motor 413 is driven, the feed screw 412 rotates and thereby moves the first moving section 41 linearly along the guide rails 46.

On a front side of the main body of the first moving section 41, there is provided a holding mechanism 414 for holding the barrel 11a. The holding mechanism 414 has a pair of claws 414a to grasp the barrel 11a from sides. Each in the pair of claws 414a is screwed with one of two threads which are cut in mutually opposing directions on a feed screw 414b. The feed screw 414b is connected to a rotating shaft of a motor 414c. As the motor 414c drives, the feed screw 414b rotates, whereby the two claws 414a are moved closer to or away from each other. The claws 414a are formed with recesses to house the flange formed in the barrel 11a.

The second moving section 42 is guided in the plunger-moving direction by a slider 421 which is engaged with the pair of guide rails 46. On a back side of a main body of the second moving section 42, a nut block 422 is fixed. The nut block 422 is screwed with a feed screw 423. The feed screw 423 has its one end connected to a rotating shaft of an unillustrated motor which is fixed to a lower portion of the support 44 whereas its another end is supported by a bearing block 425 which is fixed on a wall surface of the support 44. As the motor drives, the feed screw 423 rotates and thereby moves the second moving section 42 linearly along the guide rails 46.

On a front side of the main body in the second moving section 42, there is provided a holding mechanism 424 for holding an end (flanged portion) of the plunger 11b in the syringe 11. The holding mechanism 424 has a slit correspondingly sized to the thickness of the end of the plunger 11b. The end of the plunger 11b is held in the slit, and as the second moving section 42 moves, the plunger 11b is moved in the plunger-moving direction.

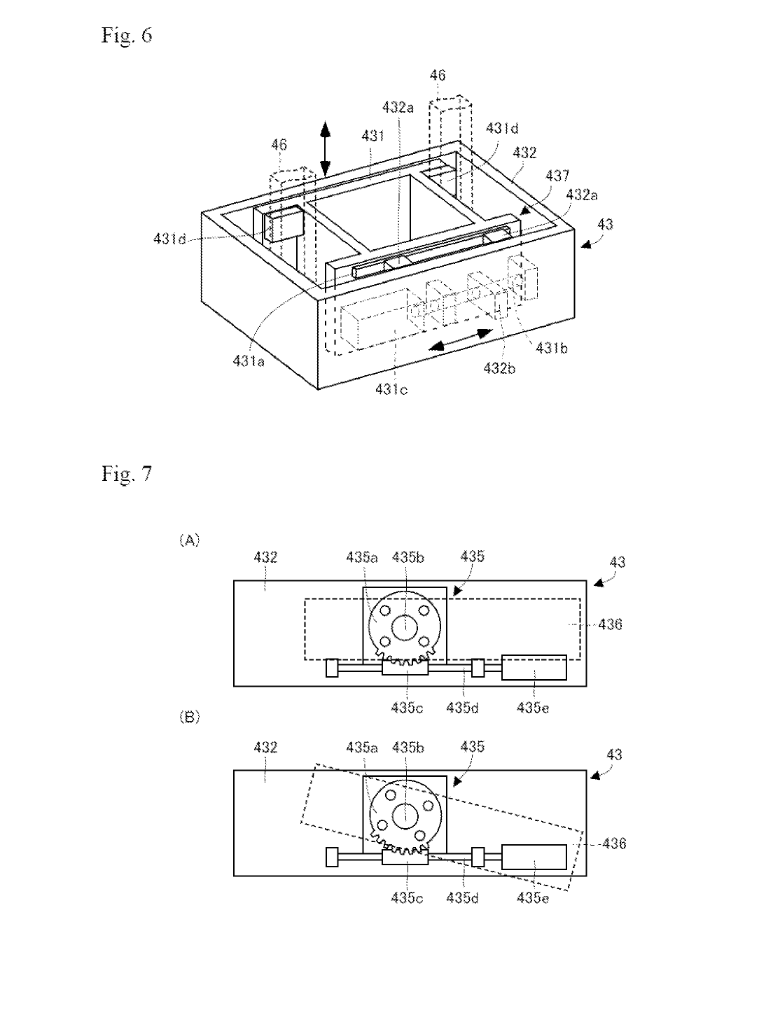

As shown also in FIG. 6, the third moving section 43 is constituted by a first main body section 431 and a second main body section 432 surrounding the first main body section 431. On the back side of the first main body section 431, a guide rail 431a is fixed transversely. Then, on an inner side of a back plate in the second main body section 432, a slider 432a is fixed, and this slider 432a is engaged with the guide rail 431a. Specifically, the second main body section 432 is slidable with respect to the first main body section 431 laterally in a direction across the guide rails 46. With the above, on the back side of the first main body section 431, a feed screw 431b is provided laterally. The feed screw 431b is connected to a rotating shaft of a motor 431c. Also, on an inner side of a back plate in the second main body section 432, a nut block 432b is fixed. The nut block 432b is screwed with the feed screw 431b. As the rotating shaft of the motor 431c rotates, the second main body section 432 is slid with respect to the first main body section 431 in the lateral direction.

The second main body section 432 is provided with a container holding section 436 (see FIGS. 4 and 5) which will be described later. The second main body section 432, the slider 432a, the guide rail 431a, the motor 431c, the nut block 432b and the feed screw 431b constitute a container slider section 437 which moves the container holding section 436 in a direction across the plunger-moving direction.

The first main body section 431 has a slider 431d fixed thereto. The third moving section 43 is moved in the plunger-moving direction by the slider 431d which is engaged with and thus guided by the pair of guide rails 46. An unillustrated nut block is fixed on a back side of the first main body section 431 in the third moving section 43. This nut block is screwed with a feed screw 433 shown in FIG. 4. The feed screw 433 is connected to a rotating shaft of a motor 434 which is fixed to the support 44. As the motor 434 is driven, the feed screw 433 rotates and thereby moves the first main body section 431 along the guide rails 46. The second main body section 432 is connected to the first main body section 431 by the container slider section 437, and thus the first main body section 431 and the second main body section 432 move integrally with each other as the third moving section 43.

As shown also in FIG. 7(A) and FIG. 7(B), on a front side of the second main body section 432 in the third moving section 43, there is provided a container tilting section 435 which tilts the vial 10 further by individually pivoting the container holding section 436, in addition to the tilting operation performed to the vial 10 by the pivoting operation of the support 44. The container holding section 436 is supported by a support 435a in the container tilting section 435. The support 435a is pivotable around a horizontal shaft 435b which is fixed to the second main body section 432. Also, the support 435a is formed with a gear section. The gear section engages with a worm gear 435c. The worm gear 435c is formed on a rotating shaft 435d. The rotating shaft 435d is rotated by a motor 435e which is fixed to the second main body section 432. The motor 435e is driven to pivot the support 435a whereby the container holding section 436 which is supported by the support 435a is pivoted to tilt.

Also, as shown in FIG. 5, the container holding section 436 has a pair of claws 436a to grasp the vial 10 from sides. Each in the pair of claws 436a is screwed with one of two threads cut which are in mutually opposing directions on a feed screw 436b. The feed screw 436b is connected to a rotating shaft of a motor 436c. As the motor 436c is driven, the feed screw 436b rotates whereby the two claws 436a are moved closer to or away from each other. The claws 436a are formed with triangular recesses suitable for holding the vial 10 or an unillustrated ampoule 10A. Also, the motor 436c is provided with torque control, so that the claws 436a will grasp the vial 10, etc. with an appropriate amount of force.

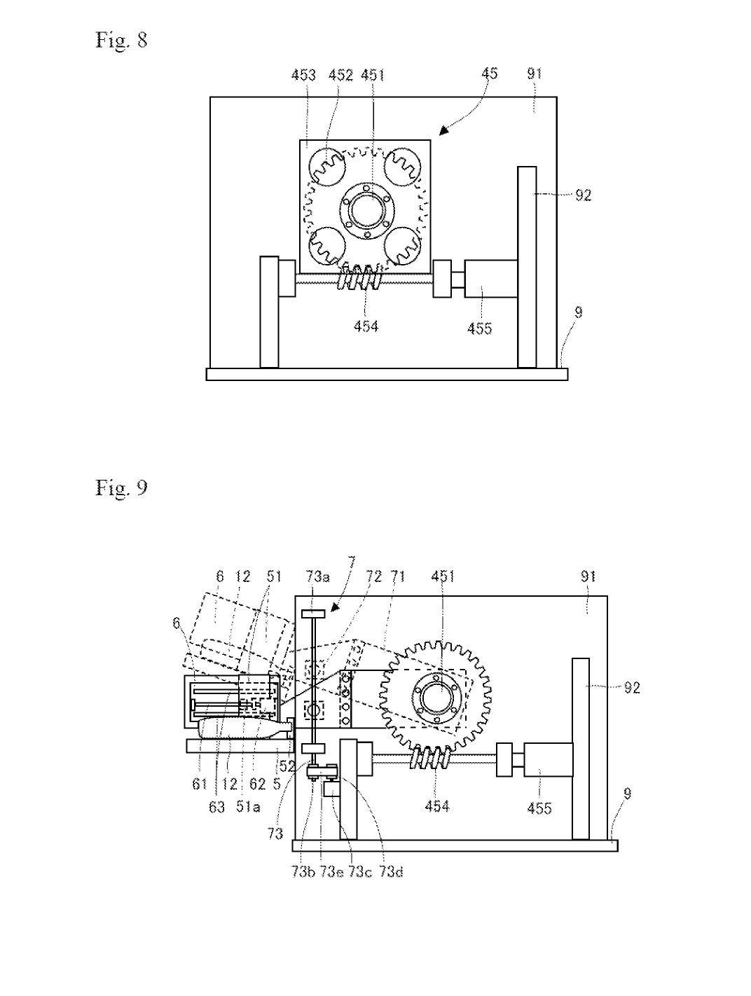

Also, as shown in FIG. 8, the pivot tilter driving section 45 has a gear 452 which is supported rotatably by a horizontally disposed cylindrical shaft 451. The cylindrical shaft 451 is provided on a back wall 91 erected on the base 9. The gear 452 has a rectangular mounting plate 453 fixed thereto, so as the gear 452 is turned, the mounting plate 453 is turned. The support 44 is fixed to this mounting plate 453. The gear 452 is connected to a worm gear 454 on its lower side. The worm gear 454 is engaged with a rotating shaft of a motor 455. As the motor 455 is driven, the worm gear 454 is rotated. The motor 455 is fixed on a side wall 92 erected on the base 9. It should be noted here that electric-power supply lines, etc. for the first, the second, and the third moving sections 41, 42, 43 and other components disposed in the support 44 of the co-infusion section 4 can be routed out through the cylindrical shaft 45. Also, electric-power supply wires, etc. connected to the first moving section 41 is routed through a wire routing conduit 47 shown in FIG. 1 whereas electric-power supply wires, etc. connected to the third moving section 43 are routed through a wire routing conduit 48.

As shown in FIG. 9 and FIG. 1, a transfusion bag 12 is placed on the transfusion bag holding section 5 and is held by a pair of holding claws 52. The holding claws 52 grasp a mixing port of the transfusion bag 12 from sides, and are actuated by an unillustrated feed screw which has two threads cut in mutually opposing directions. The transfusion bag holding section 5 is connected to the transfusion bag moving section 6 with a connecting section 51. The connecting section 51 has a nut block 51a fixed thereto. Also, the transfusion bag moving section 6 has a feed screw 61 disposed laterally. The feed screw 61 screws into the nut block 51a. Also, the connecting section 51 has an unillustrated slider fixed thereto. The slider is engaged with a guide rail 63 which is provided in the transfusion bag moving section 6. On a back side of a main body in the transfusion bag moving section 6, a motor 62 is fixed. With these arrangements, the feed screw 61 is connected to a rotating shaft of the motor 62 via unillustrated pulleys and a belt. As the motor 62 is driven, the feed screw 61 rotates, whereby the connecting section 51 moves and the transfusion bag holding section 5 moves with the connecting section 51. This movement of the transfusion bag holding section 5 is performed when inserting a needle of the syringe 11 into the mixing port of the transfusion bag 12.

The transfusion bag moving section 6 is connected and fixed to a tip of an arm section 71 in the transfusion bag tilting section 7. The arm section 71 has a base end section, which is fitted around the cylindrical shaft 451, so the arm section 71 makes a rise-lower action around the cylindrical shaft 451. The cylindrical shaft 451 has its center on a center axis of the barrel 11a of the syringe 11 which is held by the co-infusion section 4.

A nut block 72 is provided at a substantial center on a back surface of the arm section 71. The nut block 72 is screwed with a vertical feed screw 73. The feed screw 73 has its upper end supported by a bearing 73a whereas its lower end is connected to a pulley 73b. The pulley 73b receives a rotating force from a motor 73c via a pulley 73d and a belt 73e. As the motor 73c is driven, the feed screw 73 rotates to move the nut block in an up-down direction, and this up-down movement causes the arm 71 to be lifted and lowered. This lifting and lowering movement tilts the transfusion bag moving section 6, causing the transfusion bag holding section 5 to tilt. It should be noted here that the nut block 72 which is moved by the feed screw 73 rises and lowers along an arc orbit around the cylindrical shaft 451 as a center. Therefore, it is necessary that an end of the feed screw 73 is made movable for example, to absorb displacement caused by the arc movement; or for example, that the nut block 72 is of a design capable of absorbing the displacement caused by the arc movement.

In the present embodiment, the co-infusion section 4 and the transfusion bag moving section 6 constitute the insertion operation section which performs an operation of inserting the needle of the syringe 11 into a mouth of the vial 10 held by the container holding section 436; and an operation of inserting the needle of the syringe 11 into the mixing port of the transfusion bag 12. It should be noted here that the distance between the transfusion bag 12 and the syringe 11 can be changed by a movement of only one of the transfusion bag 12 and the syringe 11; therefore, the operation of inserting the needle into the mixing port of the transfusion bag 12 may be performed by carrying out only one of the two movements, i.e., the movement of the transfusion bag 12 by the transfusion bag moving section 6, and the movement of the syringe 11 by the first moving section 41 and the second moving section 42 in the co-infusion section 4.

Next, description will cover a mixing process performed by the co-infusion apparatus 1, i.e., a process of mixing a medicine which is stored in a vial 10 with a transfusion which is stored in a transfusion bag 12. It should be noted here that the mixing operation is performed by controlling each of the motors described thus far, by the controller. The motors controlled by the controller are stepping motors. By controlling the number of electric pulses supplied to a stepping motor, an angle of rotation of the rotating shaft in the stepping motor can be controlled, and by controlling excitation mode of a coil, normal rotation or reverse rotation can be selected.

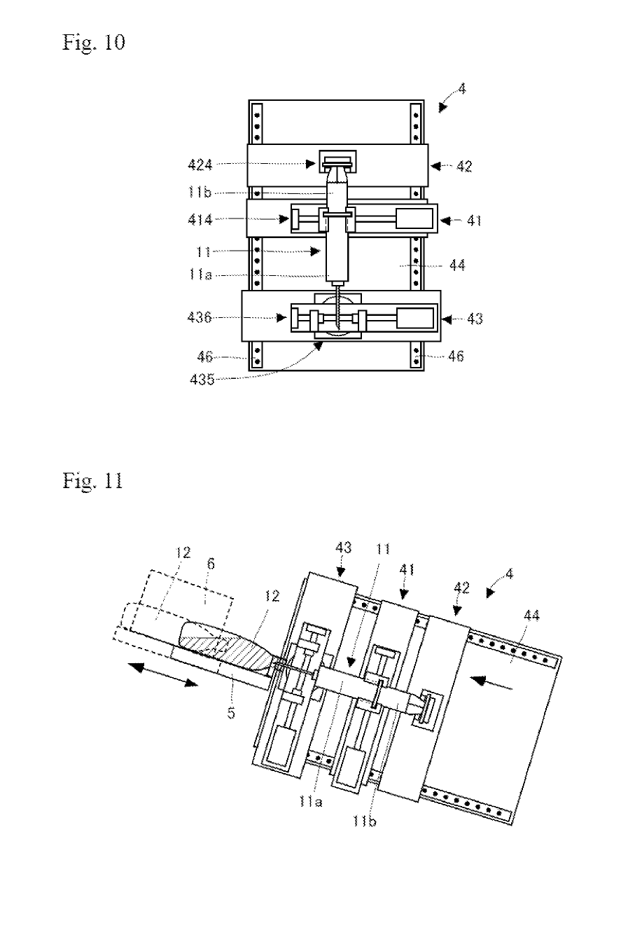

FIG. 10 shows a state where the co-infusion section 4 is upright. It should be noted here that FIG. 10 through FIG. 25 do not show the pivot tilter driving section 45, the support 435a of the container tilting section 435, or others. From the state shown in the FIG. 10, the co-infusion section 4 is turned to a state shown in FIG. 11, in which the needle of the syringe 11 is pointing obliquely upward. Under this state, the transfusion bag holding section 5 is also tilted, so the transfusion bag 12 is tilted, and the mixing port of the tilted transfusion bag 12 is now opposed to the needle of the tiled syringe 11. Also, during this, the transfusion bag moving section 6 moves the transfusion bag holding section 5 toward the co-infusion section 4. Further, the co-infusion section 4 moves the first, the second and the third moving sections 41, 42, 43 to move the syringe 11 closer to the transfusion bag 12. These movements insert the needle of the syringe 11 into the mixing port of the transfusion bag 12. Also, in the first and the second moving sections 41, 42, the plunger 11b is already pushed into the barrel 11a of the syringe 11. Additionally, the distance between the two claws 436a in the container holding section 436 is now increased so that the claws 436a will not interfere with the transfusion bag holding section 5.

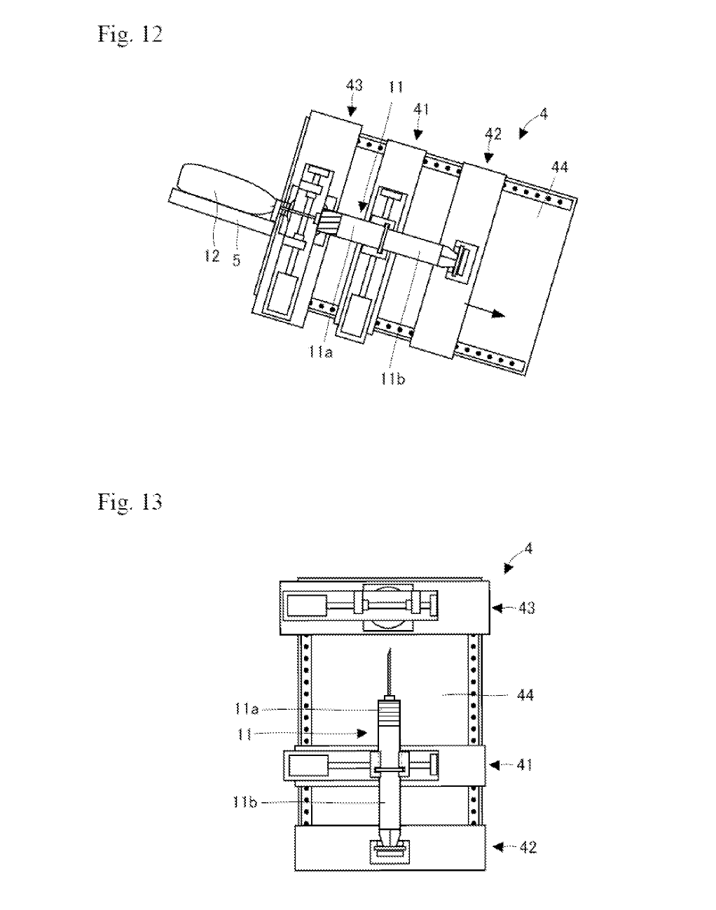

Next, as shown in FIG. 12, the co-infusion apparatus 1 moves the second moving section 42 away from the first moving section 41 whereby the plunger 11b is pulled from the barrel 11a of the syringe 11. As a result, a transfusion in the transfusion bag 12 is drawn into the barrel 11a. The second moving section is moved by a predetermined distance (by applying a predetermined amount of electric-pulse power to the motor) so that the transfusion is drawn by an amount specified in the mixing instruction sheet in the form of the bar code, or by an amount which is slightly more than the specified amount in order to allow for an air purging operation to exclude air from inside the syringe 11 as will be described later.

At this point, the transfusion bag 12 is inclined as described already. So, the mixing port of the transfusion bag 12 is oriented obliquely downward, and so the transfusion gathers on the mixing port side, with air being away from the mixing port. This decreases or prevents a problem that air in the transfusion bag 12 will enter the syringe 11 when the syringe 11 sucks the transfusion.

Next, as shown in FIG. 13, the co-infusion apparatus 1 turns the support 44 of the co-infusion section 4, to turn the syringe 11 upside down. As the needle of the syringe 11 is pointed right upward in this inverting operation, air in the barrel 11a of the syringe 11 moves toward the needle. Under this state, the second moving section 42 is brought closer to the first moving section 41 to adjust the amount of transfusion to the amount specified by the bar code in the mixing instruction sheet while purging the air from inside the barrel 11a. It should be noted here that while the needle of the syringe 11 is being pointed to right above, another operation is performed simultaneously to bring the transfusion bag holding section 5 back from the inclined position.

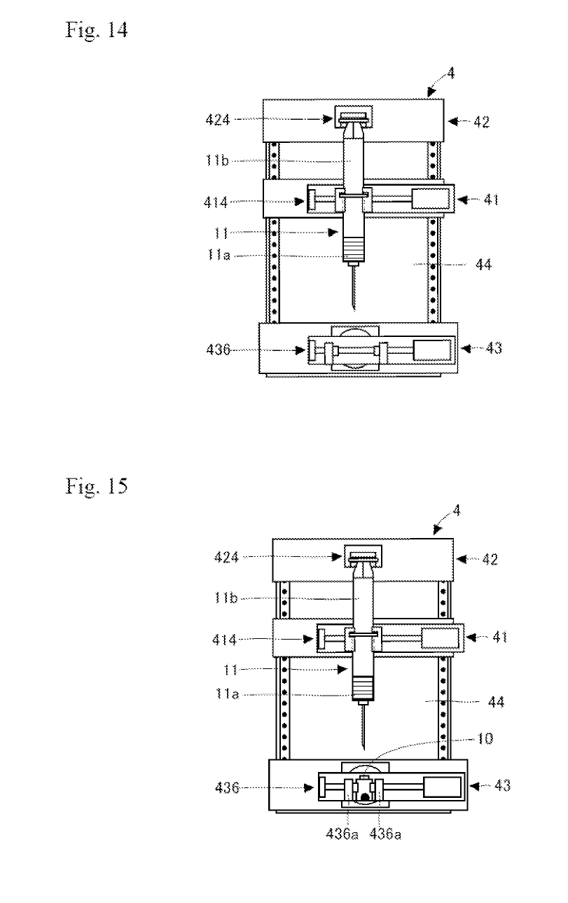

Next, as shown in FIG. 14, the support 44 of the co-infusion section 4 is turned to point the needle of the syringe 11 right below.

Next, as shown in FIG. 15, the pair of claws 436a in the container holding section 436 is actuated to grasp the vial 10. In this operation of gripping the vial 10, the driving section 8 moves the carrier device 2 closer to the co-infusion section 4.

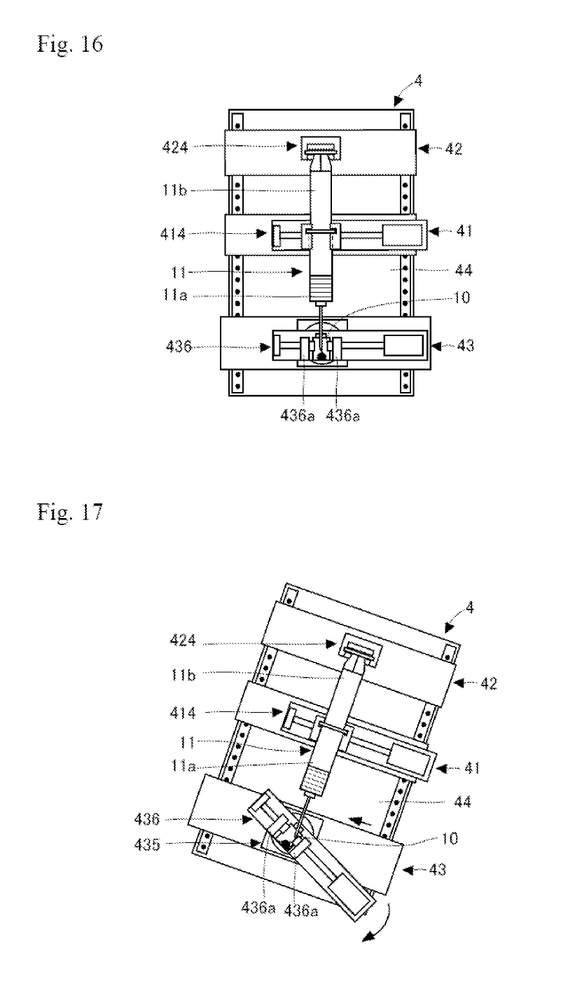

Next, as shown in FIG. 16, while maintaining the relationship between the first moving section 41 and the second moving section 42, the distance from these to the third moving section 43 is decreased. As a result, the syringe 11 which is held by the first moving section 41 and the second moving section 42 has its needle inserted straightly into the center of the cap (mouth) in the vial 10 which is held by the container holding section 436 in the third moving section 43.

Next, as shown in FIG. 17, the support 44 of the co-infusion section 4 is turned to tilt the syringe 11 and the vial 10 clockwise, while the container tilting section 435 turns the container holding section 436 individually, whereby the vial 10 is tilted further clockwise in the figure while the syringe 11 is kept in the same attitude. Simultaneously with this, the container slider section 437 moves the vial 10 linearly to the left in the figure. The center of turning when tilting the vial 10 is lower than the cap of the vial 10; therefore, as the vial 10 is tilted, the cap of the vial 10 moves to the right in the figure. Therefore, in order to cancel this rightward movement of the cap, the container slider section 437 moves the vial 10 linearly to the left. It should be noted here that the vial 10 makes a linear movement obliquely in an upper-left direction in FIG. 17 since the container slider section 437 slides the container holding section 436 laterally in the third moving section 43 which is in a tilted state.

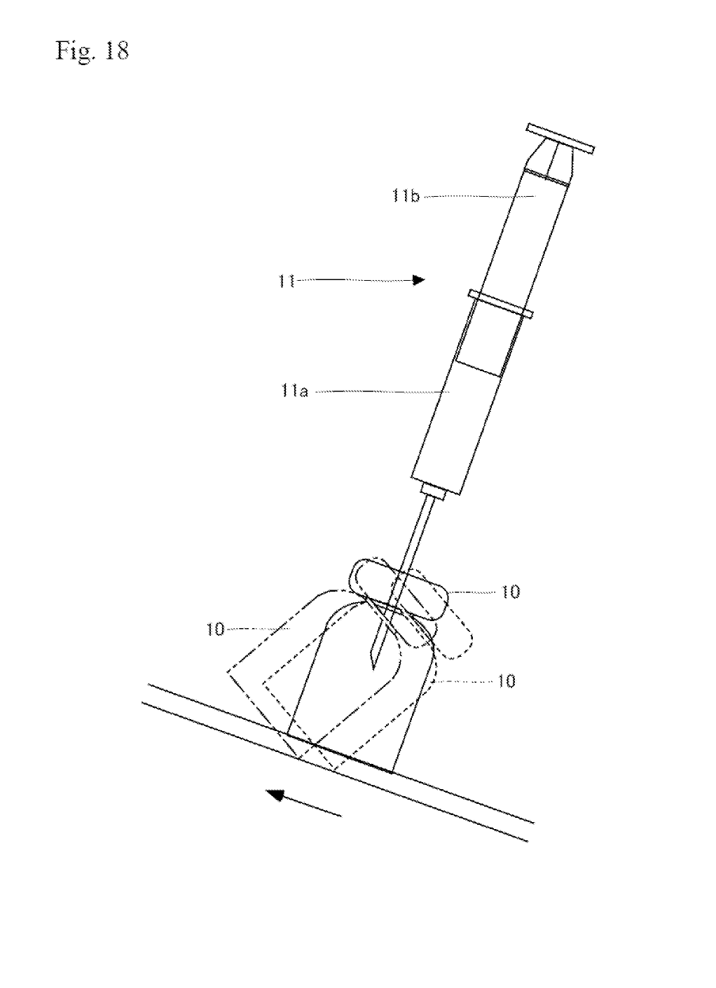

FIG. 18 shows the syringe 11 and the vial 10 in the state shown the FIG. 17, in an enlarged view. In FIG. 18, solid lines illustrate the state where the syringe 11 and the vial 10 are tilted clockwise whereas broken lines illustrate the state where the vial 10 is tilted further clockwise while the syringe 11 is kept in the same attitude. Also, alternate long and two short dashes lines in FIG. 18 illustrate the state where the vial 10 is moved linearly in a direction indicated by an arrow. FIG. 18 illustrates an example where the syringe 11 and the vial 10 are tilted by 20 degrees, and then from this angle, the vial 10 is tilted further by 30 degrees. The vial 10 is moved by 7.7 mm in a direction indicated by an arrow.

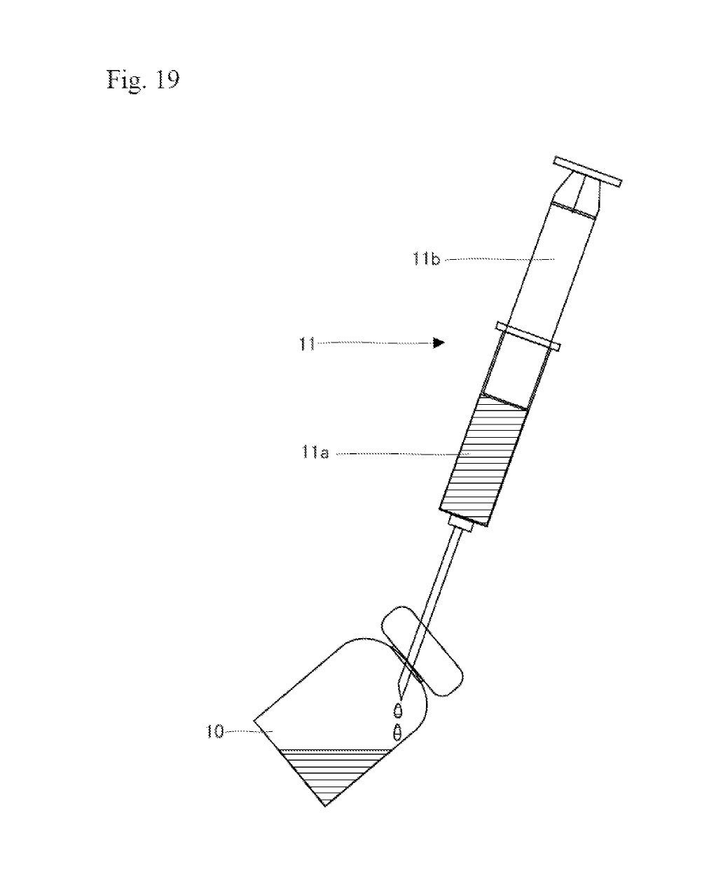

By combining the linear and the turning movements as described above, when infusing the transfusion inside the syringe 11 to the vial 10 as shown in FIG. 19, it is now possible to drip the transfusion on the inner wall surface of the vial 10 thereby let the liquid flow down gently along the inner wall surface to the bottom. It is now possible, when putting the transfusion into the vial 10, to prevent the transfusion from foaming or directly hitting the medicine inside the vial 10, and thus prevent foaming during the mixing of the transfusion and the powdery medicine. Further, when the vial 10 is individually turned to tilt, it is now possible as described above, to slide the vial 10 thereby decrease relative positional change between the vial 10 and the needle which is inserted through the container cap. This prevents the needle hole in the cap from unduly being enlarged by the movement of the needle. In other words, it is no longer necessary that the cap (rubber closure) is made of a material superior in stretchability.

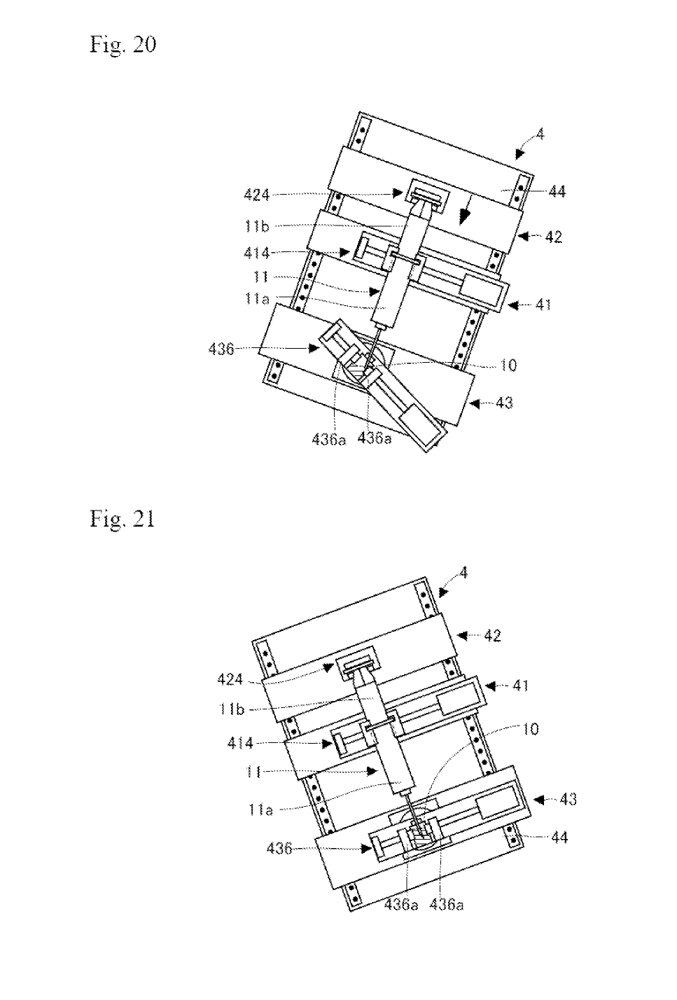

FIG. 20 shows a state where the second moving section 42 has been moved closely to the first moving section 41 while keeping the vial 10 tilted as described above, and then transfusion inside the syringe 11 is being infused in the vial 10. When moving a transfusion from inside a syringe 11 to inside a vial 10, air inside the vial 10 is first introduced into the syringe 11, and thereafter the transfusion is infused to the vial 10, and this cycle is repeated.

Next, as shown in FIG. 21, the support 44 of the co-infusion section 4 is turned to tilt the syringe 11 and the vial 10 counterclockwise by 20 degrees for example, while the container tilting section 435 turns the container holding section 436 back to the previous attitude, whereby the positional relationship between the syringe 11 and the vial 10 is brought back to the original, non-tilted state. Also, when bringing the positional relationship between the syringe 11 and the vial 10 to the original, non-tilted state as the above, the state created by the container slider section 437 as a result of linear movement of the vial 10 is brought back to the original state, so that the needle of the syringe 11 is at the center of the cap of the vial 10. By tilting the syringe 11 and the vial 10 counterclockwise as shown in FIG. 21 by turning the co-infusion section 4, the transfusion in the vial 10 now makes contact with the opposite side of the container's wall surface which was contacted when the transfusion was infused. This helps prevent situations where any portion of the medicine is left un-contacted by the transfusion and remain un-dissolved in the vial 10.

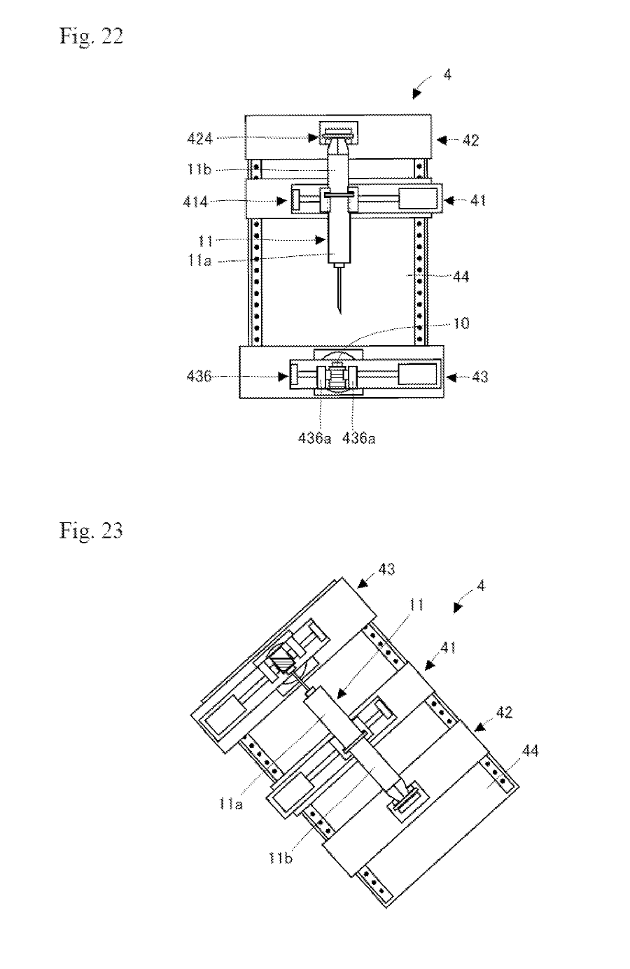

Next, as shown in FIG. 22, the support 44 of the co-infusion section 4 is brought back to the original, upright state to bring the syringe 11 into an upright attitude. Simultaneously with this, the first moving section 41 and the second moving section 42 are moved upward with respect to the third moving section 43.

Then, the vial 10 which now contains the transfusion is passed to the mixing section 3, where a shaking operation is performed to dissolve the medicine into the transfusion. Then, after this mixing procedure, the vial 10 is passed again to the container holding section 436 of the co-infusion section 4.

Next, as shown in FIG. 23, the support 44 of the co-infusion section 4 is turned to tilt the syringe 11 and the vial 10 clockwise by 160 degrees for example, to move the medicine-transfusion mixture inside the vial 10, onto the cap side. Under this state, the tip of the needle of the syringe 11 is pointing obliquely upward. In the mean time, the syringe 11 is operated to suck an amount of air which corresponds to a volume of the medicine-transfusion mixture inside the vial 10. Then, a cycle of operations of moving the medicine-transfusion mixture from the vial 10 to the syringe 11 and moving the air from the syringe 11 to the vial 10 is repeated for several times. Specifically, the co-infusion apparatus 1 operates the second moving section 42 to move the plunger 11b of the syringe 11 so that such a cycle of operations as the above will be implemented.

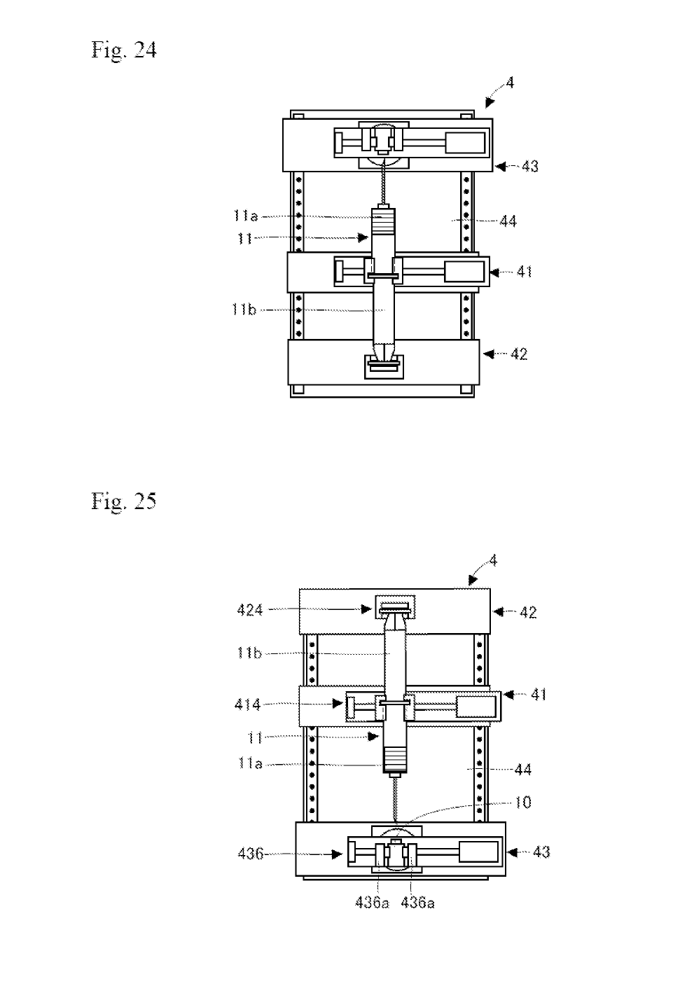

Then, as shown in FIG. 24, as the amount of the medicine-transfusion mixture decreases in the vial 10, the support 44 of the co-infusion section 4 is turned further until the vial 10 becomes upside down, to move all of the remaining medicine-transfusion mixture from the vial 10 to the syringe 11. Thereafter, air in the syringe 11 is discharged into the vial 10.

Next, as shown in FIG. 25, the co-infusion apparatus 1 turns the support 44 of the co-infusion section 4, to bring the co-infusion section 4 into a non-tilted state (in which the syringe 11, etc. are upright). Also, the co-infusion apparatus 1 moves the first moving section 41 and the second moving section 42 to bring the syringe 11 away from the vial 10.

Then, the empty vial 10 is passed to the carrier device 2, and a new vial 10 is received at the container holding section 436 in the third moving section 43 of the co-infusion section 4. Then, the cycle of the above-described operations is repeated until a predetermined amount of medicine is dissolved in the transfusion inside the syringe 11.

Once the predetermined amount of medicine has been dissolved in the transfusion inside the syringe 11, the transfusion bag 12 is made horizontal in the transfusion bag holding section 5 as illustrated in solid lines in FIG. 9 for example; the needle of the syringe 11 is then inserted into the mixing port; and the transfusion inside the syringe 11 is returned to the transfusion bag 12. It should be noted here that this process may alternatively be performed under the state illustrated in broken lines in FIG. 9, i.e., the arm section 71 in the transfusion bag tilting section 7 is tilted so that the transfusion bag 12 has its mixing port tilted to point obliquely downward in the transfusion bag holding section 5, and under this state, the needle of the syringe 11 is inserted into the mixing port to return the medicine-transfusion mixture from the syringe 11 to the transfusion bag 12. Still alternatively, the arm section 71 in the transfusion bag tilting section 7 may be tilted to the other side as opposed to the state illustrated in broken lines in FIG. 9 so that the transfusion bag 12 has its mixing port tilted to point obliquely upward in the transfusion bag holding section 5, so that the needle of the syringe 11 is inserted into the mixing port to return the medicine-transfusion mixture from the syringe 11 to the transfusion bag 12 under this state.

It should be noted here that in the embodiment described above, the container holding section 436 is tilted by the container tilting section 435. However, the present invention may also take a configuration which does not include the container tilting section 435. In this configuration, there is a situation where the needle of the syringe 11 is inserted into the vial 10; the direction in which the plunger will move is slanted, but the tip of the needle is still pointing the bottom of the vial 10; however, it is possible to bring the inner wall surface of the vial 10 to right below the tip of the needle. This situation enables to infuse the transfusion to the inner wall surface of the vial 10 and thereby to pour the liquid gently along the inner wall surface to the bottom when moving the transfusion from the syringe 11 into the vial 10.

Another alternative configuration can be that which includes the container tilting section 435 but does not include the container slider section 437. In this configuration, when the vial 10 is tilted by the container tilting section 435, the tilting operation causes relative movement of the needle of the syringe 11 from the center of the cap of the vial 10 toward the edge. However, as far as the vial 10 is tilted by the container tilting section 435 within a range which tolerates this relative movement, the configuration further makes sure to infuse the transfusion to the inner wall surface of the vial 10 and thereby to pour the liquid gently to the bottom to the degree the tilting is made.

Next, description will cover a case where the medicine container is provided by an ampoule. A mixing cycle involving ampoules includes: an operation of passing an ampoule from the carrier device 2 to the co-infusion section 4; an operation of sucking a liquid medicine from inside an ampoule using a syringe 11 which is held by the co-infusion section 4; an operation of returning the ampoule from which the liquid medicine was sucked, to the carrier device 2; repeating the sequence of the above-described operations, i.e., receiving the ampoule, sucking liquid medicine, and returning the ampoule, for as many ampoules as necessary; and then injecting the liquid medicine from inside the syringe 11 into a transfusion bag 12.

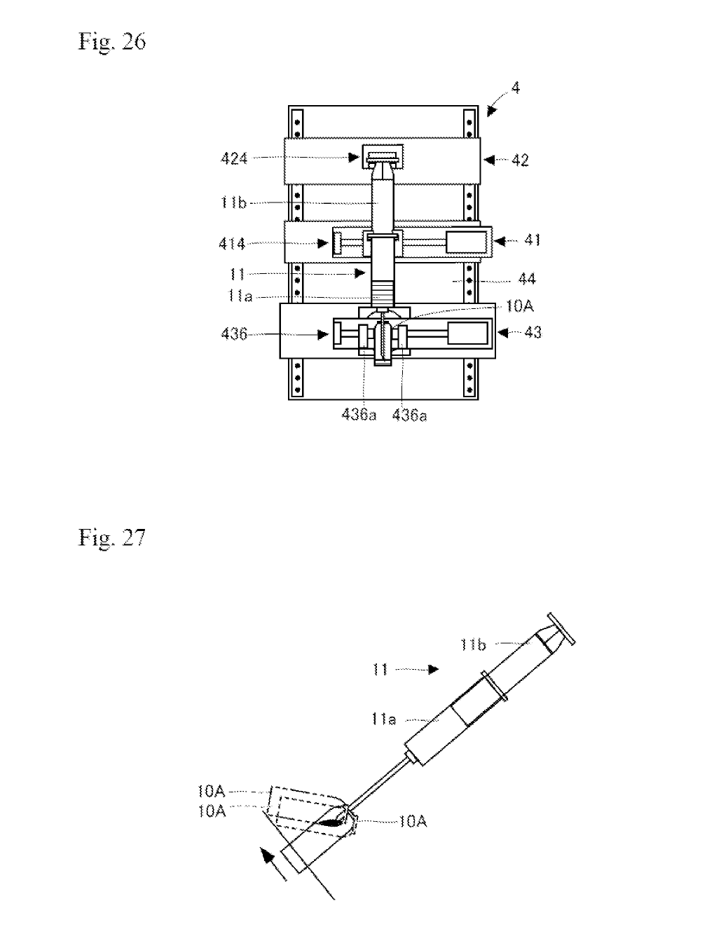

As shown in FIG. 26, when an ampoule 10A is utilized, the co-infusion section 4 is not turned initially but the ampoule 10A is kept upright, and under this state, a liquid medicine in the ampoule 10A is sucked into the syringe 11. For example, if the ampoule 10A is a 5-ml container, only 4 ml is sucked from the container, leaving the remaining 1 ml liquid medicine in the ampoule 10. It should be noted here that the invention is not limited to the above-described case in which the ampoule 10A is kept upright; i.e., the container tilting section 435 may be actuated to tilt the ampoule 10A by a few degrees for example.

After the sucking of the above-mentioned 4 ml is completed, or while the sucking operation is still underway toward completion, the co-infusion apparatus 1 tilts the syringe 11 and the ampoule 10A clockwise by 50 degrees for example, as illustrated in solid lines in FIG. 27. Further, once the sucking of the 4 ml is completed, the apparatus tilts the ampoule 10A by 50 degrees as illustrated in broken lines in the figure, and at the same time, the apparatus moves the ampoule 10A linearly by 4.0 mm as illustrated in alternate long and two short dashes line in FIG. 27 in a direction indicated by an arrow. The above-described overall 50-degree turning of the syringe 11 and the ampoule 10A is accomplished by turning the co-infusion section 4 by the pivot tilter driving section 45 whereas the subsequent 50-degree turning of the ampoule 10A is accomplished by individually turning the container holding section 436 by the container tilting section 435. The linear movement of the ampoule 10A is accomplished by the container slider section 437.

As described, when the medicine container is provided by an ampoule 10A, a certain amount of liquid medicine is sucked while the ampoule 10A is held upright, and thereafter the ampoule 10A is tilted from the upright state by approximately 100 degrees, in order to gather the liquid medicine at a neck region of the ampoule 10A (FIG. 27 illustrates the liquid medicine in the ampoule 10A as a solid-black object). Creating this state enables to suck as much liquid medicine so there is little solution left in the container, without allowing the tip of the needle of the syringe 11 to touch the bottom of the ampoule 10A.

There may be a configuration which involves the use of the ampoule 10A but does not include the container slider section 437. In this configuration, when the ampoule 10A is tilted by the container tilting section 435, the tilting operation causes relative movement of the needle of the syringe 11 from a center of the opening of the ampoule 10A toward the edge of the ampoule 10A. However, since the opening of the ampoule 10A is larger than the needle, it is possible to tilt the ampoule 10A by the container tilting section 435 within a range which tolerates this relative movement, and this configuration enables to suck as much liquid medicine so there is little solution left in the container, without allowing the tip of the needle of the syringe 11 to touch the bottom of the ampoule 10A to the degree the tilting is made.

It should be noted here that in the embodiments described thus far, the holding mechanism 414 which holds the barrel 11a; the holding mechanism 424 which holds the plunger 11b of the syringe 11; and the container holding section 436 are all moved in the plunger-moving direction. However, the present invention is not limited to this. For example, there may be configurations where one of the holding mechanism 414, the holding mechanism 424 and the container holding section 436 is not moved in the plunger-moving direction. In a case where the holding mechanism 424, which holds the plunger 11b, is disposed at a fixed position, the other two, i.e., the holding mechanism 414 which holds the barrel 11a, and the container holding section 436 are moved along the direction in which the immobilized plunger 11b is moved. The direction along the direction in which the plunger 11b is moved is the plunger moving direction, i.e., the direction which changes the amount of insertion of the barrel 11a into the plunger 11b.

Now, as described earlier, when the container setting stand 21 in the carrier device 2 comes in front of the co-infusion section 4, the movable table 83 moves toward the co-infusion section 4 in order to pass the vial 10 to the co-infusion section 4.

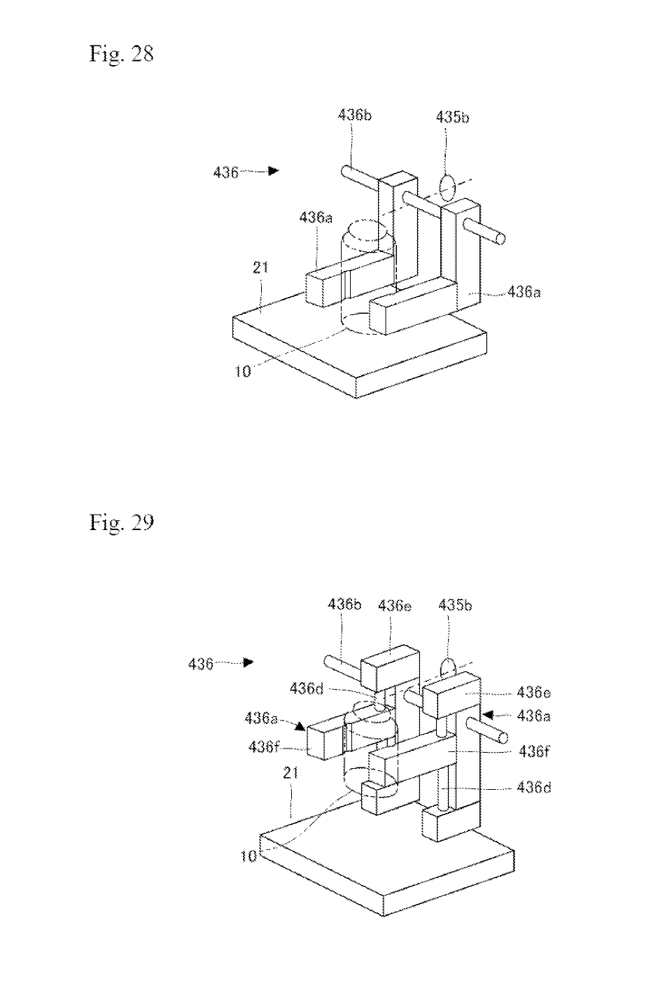

Referring now to FIG. 28, when the vial 10 on the container setting stand 21 is passed to the container holding section 436 in the co-infusion section 4, tilting the vial by the container tilting section 435 causes little positional displacement of the cap (mouth) of the vial 10 as far as the cap is in adjacency to the center of the horizontal shaft 435b (the pivot center of the container holding section 436). Therefore, it is not necessary to move the vial 10 laterally by the container slider section 437. On the other hand, if the cap (mouth) of the vial 10 is not adjacent to the center of the horizontal shaft 435b, the container slider section 437 will make a lateral movement of the vial 10 as has been described earlier.

A distance from the cap (mouth) of the vial 10 to the center of the horizontal shaft 435b will vary depending on the height of the vial 10. Therefore, upon starting a mixing operation, the co-infusion apparatus 1 makes a reference to a storage section of the controller (microcomputer), where vial height data is stored for each type of the vial. Meanwhile, the bar code on the mixing instruction sheet includes vial information, from which the apparatus identifies the type of the container and read out a corresponding height data from the storage section, and based on the retrieved height data, the apparatus can calculate the amount of lateral sliding movement of the vial 10 to be made by the container slider section 437.

On the other hand, the vial 10 may be moved in its height direction based on the vial height data, to adjust the position of the cap. In this case it is possible to eliminate positional difference between the cap (mouth) of the vial 10 and the center of the horizontal shaft 435b.

FIG. 29 shows an example for this. The claws 436a in the container holding section 436 are constituted by feed screws 436d and movable claws 436f which are screwed with the feed screw 436d, with one end of each feed screw 436d supported rotatably while the other end connected to a rotating shaft of a motor 436e. As the motors 436e rotate the feed screws 436d, the movable claws 436f are moved in an up-down direction (the height direction of the vial 10).

A co-infusion apparatus 1 which includes the movable claws 436f receives a vial 10 which was set in the container setting stand 21 by means of the movable claws 436f and thereafter, it is capable of aligning the cap of the vial 10 with the center of the horizontal shaft 435b by moving the vial 10 with the motor 436e in the up-down direction. In this case again, the controller calculates an amount of movement necessary for the movable claws 436f (the number of pulses to apply to the motor 436e) based on the vial height data mentioned earlier. It should be noted here that the data stored at the storage section in the controller (microcomputer) may not necessarily be height data for each type of the vial, but may be data which indicate the number of pulses to be applied to each of the vials.

Aligning the cap of the vial 10 with the center of the horizontal shaft 435b is achievable without the movable claws 436f. For example, it is achievable by moving the third moving section 43 in the up-down direction (the height direction of the vial 10) by a distance according to the height of the vial 10 before the vial 10, which was set in the container setting stand 21, is passed to the claws 436a as shown in FIG. 28. As the third moving section 43 moves, the claws 436a move and together with this, the horizontal shaft 435b in the container tilting section 435 moves in the up-down direction. As described above, by moving the third moving section 43 thereby moving the claws 436a and the horizontal shaft 435b in the up-down direction before the container is passed, it is possible to reduce the distance from the cap of the vial 10 to the center of the horizontal shaft 435b to zero. It should be noted here that in cases where the third moving section 43 is moved in accordance with the height of the vial 10, the first moving section 41 and the second moving section 42 are also moved by such a distance according to the movement.

Another possible arrangement will be to design the support 44 movable in the up-down direction, so that the support 44 will be moved in the up-down direction by a distance according to the height of the vial 10 being handled before the vial 10 is passed from the container setting stand 21 where it is set, to the claws 436a.

Another example may be to move the container setting stand 21 in the up-down direction (the height direction of the vial 10) by a distance according to the height of the vial 10 before the vial 10 is passed from the container setting stand 21 where it is set, to the claws 436a. As described above, it is also possible to reduce the distance from the cap of the vial 10 to the center of the horizontal shaft 435b to zero, with an arrangement in which the container setting stand 21 is moved in the up-down direction.

Still another possible arrangement will be to design the carrier device 2 movable in the up-down direction, so that the carrier device 2 will be moved in the up-down direction by a distance according to the height of the vial 10 being handled before the vial 10 is passed from the container setting stand 21 where it is set, to the claws 436a.

Various operations such as those exemplified above may be employed to achieve the alignment between the mouth of the medicine container (vial 10, ampoule 10A) and the center of individual turning (the center of the horizontal shaft 435b) of the container holding section 436.

In the embodiments described thus far, the first moving section 41, the second moving section 42 and the third moving section 43 are all mounted on the support 44 so that the medicine container and the syringe 11 are tilted together. However, the present invention is not limited to this.

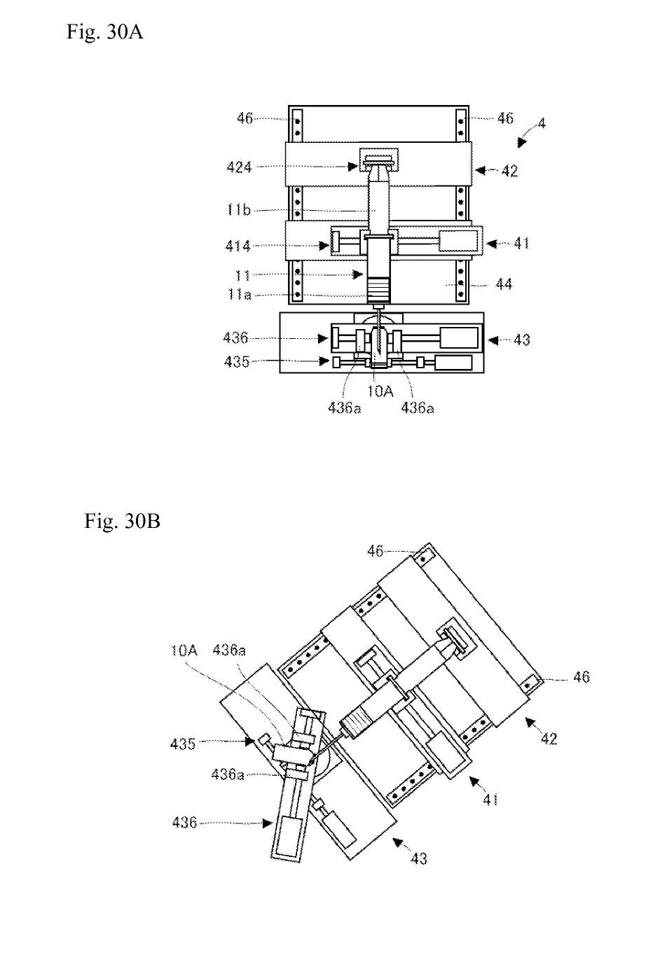

For example, as shown in FIG. 30(A) and FIG. 30(B), there may be an arrangement where the third moving section 43 is not supported by the support 44 but the third moving section 43 is made movable individually. In this arrangement, there is no need for the third moving section 43 to have a frame member made of the first main body section 431 and the second main body section 432, so the container holding section 436 and the container tilting section 435 may be supported by a simpler member. In the arrangement in FIG. 30, the third moving section 43 is moved along an unillustrated curvy guide rail in order to avoid hitting on the support 44. The curvy guide rail follows an arc for example, and the center of the arc is the center of turning movement of the support 44. Specifically, in this arrangement in FIG. 30, the syringe holding section is supported by a movable support 44, and by turning the support 44, the syringe holding section tilts the syringe 11 while on the other hand, the container holding section 436 tilts the medicine container (e.g., ampoule 10A) by means of another, curvy movement which is different from the movement of the support 44.

With the configuration shown in FIG. 30, a mixing operation can be performed in the same cycle illustrated in FIG. 10 through FIG. 27. The curvy guide rail is not limited to an arc described as the above. Also, in the configuration where the third moving section 43 is not supported by the support 44 but the third moving section 43 is designed to be moved individually, the third moving section 43 may be designed to be movable also in the up-down direction. This makes it possible to align the mouth of the medicine container with the center of individual turning of the container holding section 436 (the center of the horizontal shaft 435b).

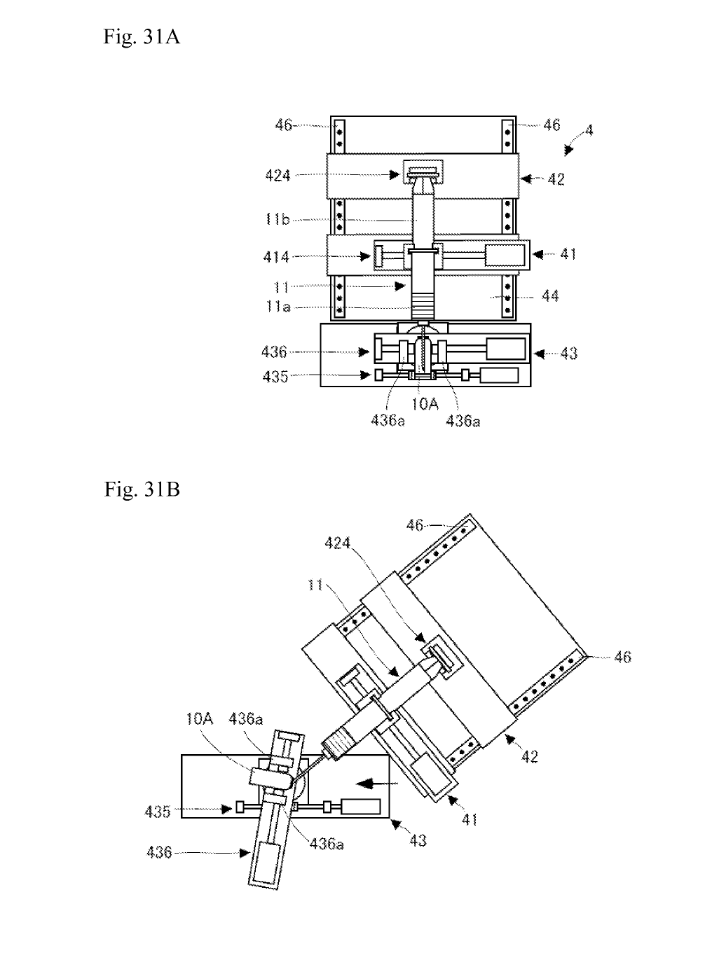

As another example, as shown in FIG. 31 (A) and FIG. 31 (B), there may be an arrangement where the third moving section 43 is not supported by the support 44 but the third moving section 43 is designed to be movable individually in lateral directions (horizontal and oblique directions). In this case again, there is no need for the third moving section 43 to have a frame member which is made of the first main body section 431 and the second main body section 432. In the configuration shown in FIG. 31, the support 44 is turned clockwise in the figure to tilt the syringe 11; the third moving section 43 is moved linearly to the left in the figure; and the container tilting section 435 is driven to tilt the ampoule 10A. The ampoule 10A is not tilted by the above-mentioned linear movement, but is tilted only by the movement of the container tilting section 435. Again, in this configuration, it is possible to tilt the medicine container by the same angle as the syringe 11 and in addition, if the container is an ampoule 10A, it is possible to tilt the ampoule 10A further, thereby creating a state where liquid medicine is gathered near the neck area of the ampoule 10A.

Also in the configuration illustrated in FIG. 31, the third moving section 43 is movable linearly in a lateral direction as has been described, and therefore, it is possible to eliminate or reduce the above-described positional displacement of the mouth of the medicine container which can be caused when the mouth is off the center of the horizontal shaft 435b in the container tilting section 435, by linearly moving the third moving section 43 in a lateral direction.

It should be noted here that in the configuration shown in FIG. 31, the third moving section 43 is linearly movable in a lateral direction as described already. However, there may be a different configuration where the third moving section 43 is fixed, and the support 44 is movable in the lateral direction together with the pivot tilter driving section 45, on the base 9. In this case, the transfusion bag holding section 5, the transfusion bag moving section 6 and the transfusion bag tilting section 7 are made independent from the cylindrical shaft 451 of the support 44, or designed so that the transfusion bag tilting section 7, etc. also move linearly in the lateral direction together with the support 44. With such a configuration as described, it is also possible to eliminate or reduce the above-described positional displacement of the mouth of the medicine container when the mouth is off the center of the horizontal shaft 435b in the container tilting section 435, by the linear movement in the lateral direction.

Also, regarding the configuration in FIG. 31, it is possible not to move the third moving section 43 laterally nor to move the support 44 laterally. In this configuration, an arrangement is made to place the tip of the needle of the syringe 11 or the barrel (desirably a region of the medicine container where there is the mouth) at a pivot center of the support 44. In such a configuration as the above, turning the support 44 to tilt the syringe 11 causes little positional change in the needle. With this arrangement, there is performed an operation as described earlier, that the mouth of the medicine container is placed in alignment with the center of the horizontal shaft 435b of the container tilting section 435. Then, tilting the medicine container by the container tilting section 435 causes little positional change in the mouth. Therefore, even in the configuration where neither the third moving section 43 nor the support 44 is moved in the lateral direction, it is still possible to tilt both of the medicine container and the syringe 11 appropriately, with the needle of the syringe 11 inserted in the mouth of the medicine container.

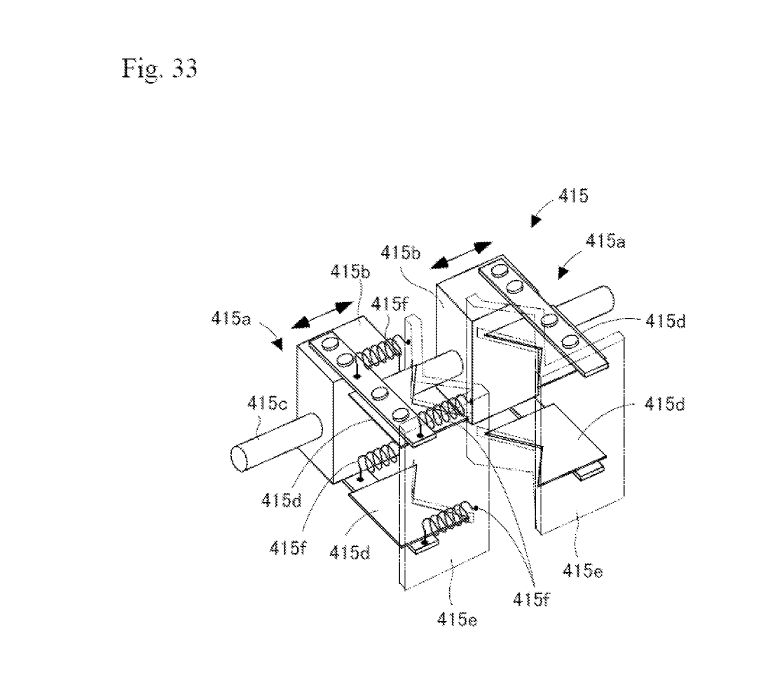

FIG. 33 is a perspective view which shows a holding mechanism 415 which is different from the holding mechanism 414. The holding mechanism 415 has a pair of claws 415a to grasp the barrel 11a from sides. Each in the pair of claws 415a is supported by a movable support 415b, which is screwed with one of two threads which are cut in mutually opposing directions on a feed screw 415c. Each of the claws 415a has two blade members 415d disposed at a space from each other in the up-down direction. Each blade member 415d has a recess shaped in V for example on edge, for making contact with the barrel 11a. In this example, the barrel 11a is made of resin, and as the barrel 11a is grasped by the blade members 415d, the contacting edges of the blades are bitten into the barrel surface. Since this biting of the blade edges work to prevent the barrel 11a from slipping in the plunger moving direction, it is possible to hold the barrel 11a securely without a need for strong grip by the claws 415a on the barrel 11a. Since it is now possible not to grip the barrel 11a strongly, the arrangement enables to prevent deformation caused by gripping the barrel 11a and to ensure smooth movement of the plunger 11b. When the barrel 11a is not gripped, cover members 415e prevent the blade members 415d from exposure. Specifically, each cover member 415e is formed with a slit faced by the blade members 415d. When a spring 415f has no pressing, the blade edges of the blade members 415d stay inside the slit, but when grasping the barrel 11a with the claws 415a, the cover members 415e first make contact with the barrel 11a to move the cover member 415e against the spring 415f, allowing the blade edges of the blade members 415d to be bitten into the barrel 11a.

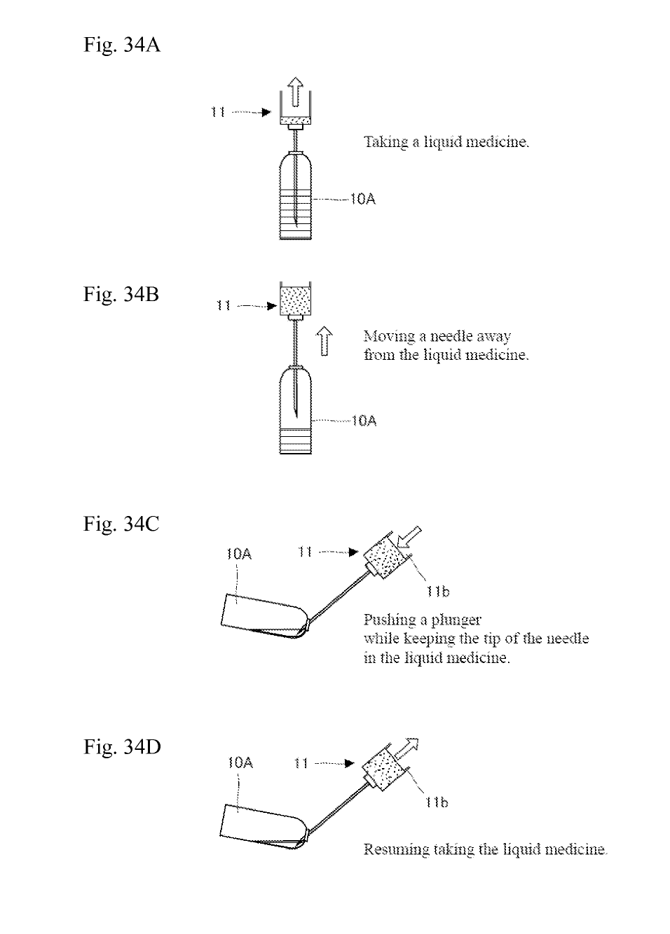

FIG. 34(A), FIG. 34(B), FIG. 34(C) and FIG. 34(D) show an example of sequence for taking a liquid medicine from an ampoule 10A with the syringe 11. When the co-infusion apparatus 1 tilts the ampoule 10A further with respect to the syringe 11 as shown in FIG. 27, the movement of the plunger 11b is stopped and as shown in FIG. 34(B), sucking of liquid medicine is halted and the needle is moved away from the liquid medicine. As the needle is lifted off the liquid medicine however, there is likelihood that air will enter the needle. To clear this problem, the co-infusion apparatus 1 performs as shown in FIG. 34(C), i.e., pushes the plunger 11b while keeping the tip of the needle in the liquid medicine which has gathered in the neck region of the tilted ampoule 10A. By pushing the plunger 11b as described as the above, air which might have been in the needle is returned to the ampoule 10A together with liquid medicine in the needle. Thereafter, as shown in FIG. 34(D), the co-infusion apparatus 1 resumes the operation of pulling the plunger 11b, thereby continuing the sucking operation of the liquid medicine. Since the purpose of this operation is simply to remove air from within the needle, the amount of push on the plunger 11b may only be to the extent to displace the volume inside the needle. Also, if the above operation of pushing the plunger 11b was performed as shown in FIG. 34(C) and then when the plunger 11b is subsequently pulled as shown in FIG. 34 (D), the plunger 11b may be drawn by an additional amount which equates to the amount by which the plunger 11b was pushed. The additional amount of drawing will take the amount of liquid medicine which was returned to ampoule 10A when the plunger 11b was pushed, back to the syringe 11, so this makes it possible to decrease the final error in the amount taken from the container.

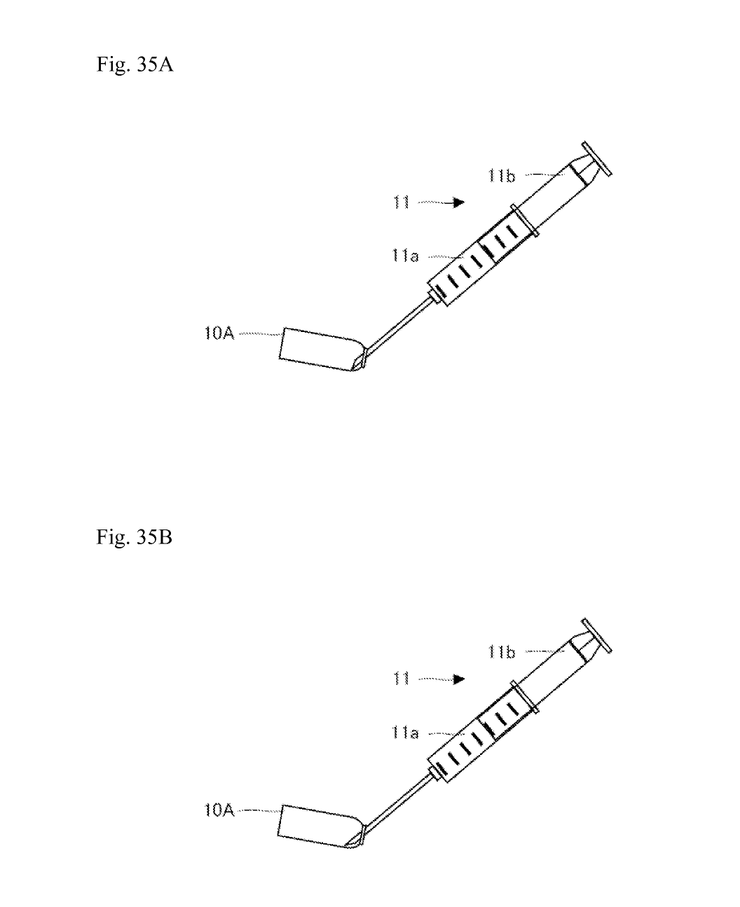

FIG. 35(A) and FIG. 35(B) show relationships between a cut-off surface at the tip of the needle and the ampoule 10A. In the example shown in FIG. 35(A), the cut-off surface at the tip of the needle is upright with respect to the inner wall surface of the tilted ampoule 10A. In this situation, it might not be possible to completely suck the liquid medicine from the ampoule 10A to the syringe 11. On the contrary, in the example shown in FIG. 35(B), the cut-off surface at the tip of the needle is substantially parallel to the inner wall surface of the tilted ampoule 10A. In this situation, it is possible that the liquid medicine will be sucked completely from the ampoule 10A to the syringe 11. It should be noted here that when setting the syringe 11 in the co-infusion apparatus 1, the syringe is set so that scale markings on the syringe will face the operator for the purpose of the audit. With this practice, it is desirable that manufacture of the syringe 11 is designed to make sure that an appropriately disposed syringe makes the cut-off surface at the tip of the needle face a predetermined direction. Alternatively, an optical sensor may be provided in the co-infusion apparatus 1. With this arrangement, the optical sensor detects the orientation of the cut-off surface at the tip of the needle, and outputs an error alarm upon detection of the state which will cause a situation in FIG. 35(A). The optical sensor may, for example, include a light emitter and a light receiver, and the light emitter and the light receiver are disposed in such a fashion that if the syringe 11 is set to cause a situation as shown in FIG. 35(A), a beam travelling toward the light receiver is intercepted due to the orientation of the cut-off surface at the tip of the needle while if the syringe 11 is set to cause a situation as shown in FIG. 35(B), the beam travelling toward the light receiver is not intercepted due to the orientation of the cut-off surface at the tip of the needle.

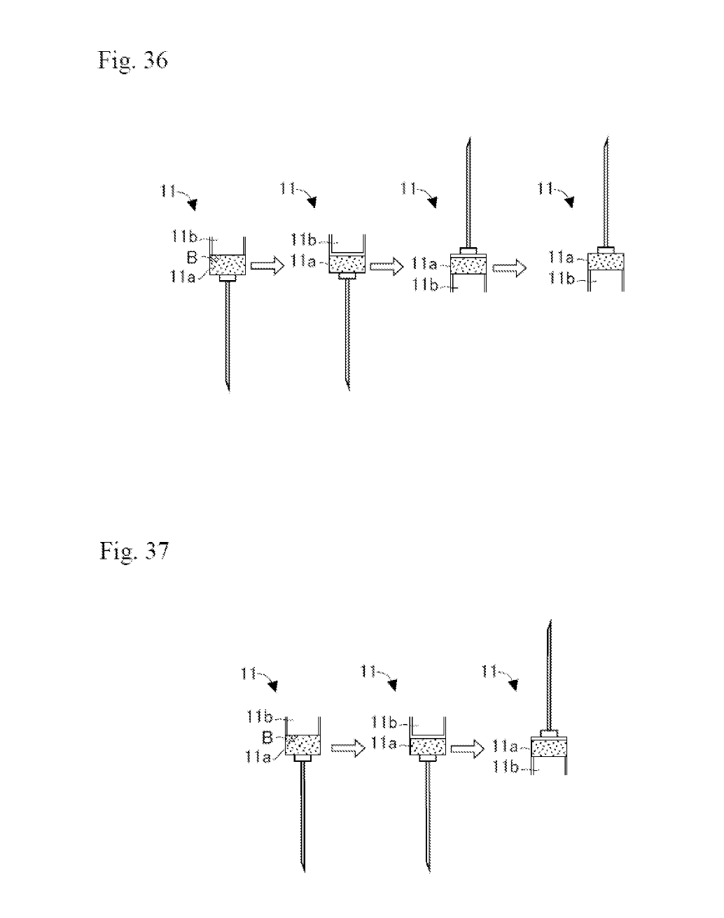

FIG. 36 shows an example operation for removing air bubbles out of the syringe 11. If air in the needle enters the syringe 11 and makes an air bubble B inside the barrel 11a when a necessary amount of liquid medicine is sucked in the syringe 11, correct reading of the amount of the liquid held inside the syringe is impossible. To solve this problem, the co-infusion apparatus 1 turns the needle downward and pulls the plunger 11b, to draw an amount of air into the barrel 11a, allowing the air to merge with the air bubble B to form a layer of air. Then, the co-infusion apparatus 1 turns the needle upward, and push the plunger 11b, to eliminate the layer of air from the barrel 11a. This removes the air bubble B from the barrel 11a, and allows accurate reading of the amount of liquid in the syringe. The air bubble B has a constant amount relevant to the volume of the needle, and the amount of the air drawn inside also has a constant amount. Therefore, the sum of these amounts represents an amount of air which must eventually be discharged out of the barrel 11a, and hence the plunger 11b is pushed by a corresponding amount.

FIG. 37 shows another example operation for removing air bubbles out of the syringe 11. In this example, elimination of the layer of air illustrated in FIG. 36 is not performed, but instead of discharging air, the layer of air is increased until its volume becomes equal to a volume represented by one scale mark (or a plurality of scale marks). As mentioned above, since the air bubble B has a constant volume in accordance with the volume of the needle, it is possible to create a layer of air which has a volume equivalent of one or more scale marks by programming the amount of air to be introduced into the syringe. When reading the amount of liquid held in the syringe, a predetermined value which represents the layer of air is subtracted from a value indicated by the end of the plunger 11b.

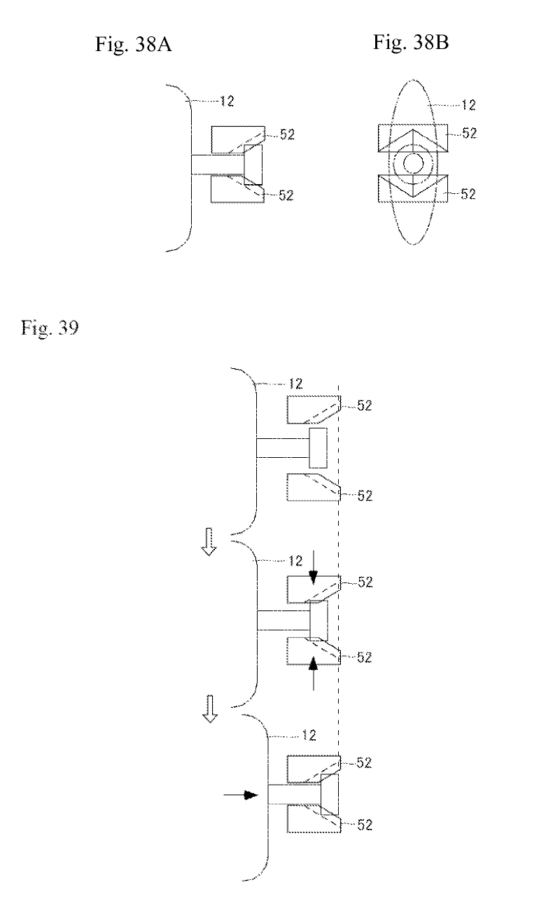

FIG. 38(A) and FIG. 38(B) show a pair of holding claws 52 in the co-infusion apparatus 1 and a transfusion bag 12. FIG. 39 show an operation of the pair of holding claws 52 of a transfusion bag holding section 5 in a co-infusion apparatus 1. Each holding claw 52 in the pair has a tapered region in its opposed surface. When the pair of holding claws 52 grasp the mixing port of the transfusion bag 12, the tapered regions work to move the mixing port toward the co-infusion section 4, i.e., closer to the side where the syringe 11 is. Due to this working, the transfusion bag 12 (mixing port) is brought to a predetermined position on the transfusion bag holding section 5. Also, the tapered regions receive a force exerted when the needle is pushed through the mixing port, and thereby prevent the transfusion bag 12 from moving off the position.

The mixing operation which has been described thus far and includes for example, a first process of inserting the needle of the syringe 11 straightly through the cap of the vial 10 and tilting the vial 10 and the syringe 11 by a predetermined angle in an integrated manner; a second process of tilting the vial 10 further with respect to the plunger-moving direction of the syringe 11; and a third process of adjusting positional relationship between the vial 10 and the syringe 11 in order to keep the needle at a center region in the cap of the vial 10 in the course of the tilting; may be performed automatically by means of manipulators (robot arms). For example, two manipulators may be employed so that one manipulator grasp the vial 10 whereas the other manipulator holds the syringe 11. Then, in the third process where the vial 10 and the syringe 11 are tilted, the manipulator works on the plunger 11b of the syringe 11 to infuse the transfusion which is held inside the syringe 11, to the vial 10.

Likewise, automatic operation by manipulators may be utilized for ampoules to perform a first process of inserting the needle of the syringe 11 through a cut-opening of the ampoule 10A which is held upright, and tilting the ampoule 10A and the syringe 11 by a predetermined angle in an integrated manner (or, the ampoule 10A inserted by the syringe 11 may be held at a slight inclination of a few degrees); a second process of tilting the ampoule 10A further with respect to the plunger-moving direction of the syringe 11; and a third process of adjusting positional relationship between the ampoule 10A and the syringe 11 in order to keep the needle at a center region in the opening of the ampoule 10A in the course of the tilting. For example, two manipulators may be employed so that one manipulator grasp the ampoule 10A whereas the other manipulator holds the syringe 11. Then, in the third process where the ampoule 10A and the syringe 11 are tilted, the manipulator works on the plunger 11b of the syringe 11 to suck the liquid medicine which is held inside the ampoule 10A, into the syringe 11.

In the configurations which involve manipulators as described above, one of the manipulators serves as the container holding section for holding the medicine container (and further, for tilting the medicine container) whereas the other of the manipulators serves as the syringe holding section for tilting the syringe 11 and varying the amount of insertion of the plunger 11b into the barrel 11a of the syringe 11. Then, both manipulators or one of the manipulators is used to insert the needle of the syringe 11 through the mouth of the medicine container. Further, the manipulator which holds the syringe 11 implements the operation of inserting the needle of the syringe 11 through the mixing port of the transfusion bag 12.

Again, for example, the configuration illustrated in FIG. 31 may be varied as follows: the third moving section 43 includes the container tilting section 435 and the container holding section 436 therein and is movable in the lateral direction; and a manipulator (robot arm) is utilized to replace an element constituted by the support 44, the first moving section 41 and the second moving section 42 (a syringe holding section which holds the syringe 11, tilts the syringe 11, and varies the amount of insertion of the plunger 11b into the barrel 11a of the syringe 11). The third moving section 43 may not necessarily be moved laterally if the manipulator moves the syringe 11 and positions the needle at the center of the mouth of the medicine container when tilting the medicine container.

Additionally, the operations illustrated in FIG. 34, FIG. 36 and FIG. 37 may also be performed by said manipulator.

While the principles of the disclosure have been described above in connection with specific apparatuses and methods, it is to be clearly understood that this description is made only by way of example and not as limitation on the scope of the disclosure.

1. A co-infusion apparatus comprising:
a container holding section for holding a medicine container and tilting the medicine container;
a syringe holding section for holding a syringe, tilting the syringe, and varying an amount of insertion of a plunger of the syringe into a barrel of the syringe; and
an insertion operation section for inserting a needle of the syringe through a mouth of the medicine container which is held by the container holding section, and inserting the needle of the syringe through a mixing port of a transfusion bag.

2. The co-infusion apparatus according to claim 1, wherein the container holding section and the syringe holding section are supported by a pivotable support so that pivoting the support causes the container holding section to tilt the medicine container, and the syringe holding section to tilt the syringe.

3. The co-infusion apparatus according to claim 1, wherein the syringe holding section is supported by a pivotable support so that pivoting the support causes the syringe holding section to tilt the syringe whereas the container holding section is movable along a curvy route to tilt the medicine container.

4. The co-infusion apparatus according to claim 2, further comprising a mechanism for individually pivoting the container holding section thereby further tilting the medicine container, in addition to the tilting of the medicine container by the pivotable support.

5. The co-infusion apparatus according to claim 3, further comprising a mechanism for individually pivoting the container holding section thereby further tilting the medicine container, in addition to the tilting of the medicine container by the moving along the curvy route.

6. The co-infusion apparatus according to claim 1, wherein the syringe holding section is supported by a pivotable support so that pivoting the support causes the syringe holding section to tilt the syringe whereas the container holding section is linearly movable in a horizontal or an oblique direction, the apparatus further comprising a mechanism for individually pivoting the container holding section to tilt the medicine container.

7. The co-infusion apparatus according to claim 1, further comprising a mechanism for individually pivoting the container holding section to tilt the medicine container.

8. The co-infusion apparatus according to claim 4, wherein the medicine container held by the container holding section has its mouth positioned at a pivot center of the individual pivoting of the container holding section.

9. The co-infusion apparatus according to claim 4, further comprising a mechanism for moving the container holding section so that moving the container holding section eliminates or reduces a positional change of the mouth of the medicine container relative to the needle caused by the individual pivoting of the container holding section.

10. The co-infusion apparatus according to claim 6, wherein the container holding section is moved in a horizontal or an oblique direction to eliminate or reduce a positional change of the mouth of the medicine container relative to the needle caused by the individual pivoting of the container holding section.

11. The co-infusion apparatus according to claim 7, wherein the syringe holding section is moved to eliminate or reduce a positional change of the mouth of the medicine container relative to the needle caused by the individual pivoting of the container holding section.

12. The co-infusion apparatus according to claim 1, wherein the syringe holding section which holds the syringe includes a blade member to be bitten into the barrel of the syringe when grasping said barrel.

13. The co-infusion apparatus according to claim 12, wherein sucking of liquid medicine from inside the medicine container into the syringe includes a sequence of: moving the needle away from the liquid medicine; tilting the medicine container; placing the needle again into the liquid medicine followed by pushing the plunger; and then resuming an operation of pulling the plunger.

14. The co-infusion apparatus according to claim 13, wherein the apparatus performs a plunger pulling operation to introduce air into the syringe and merge the air with an air bubble inside the syringe thereby creating a layer of air; and a plunger pushing operation to remove the layer of air.

15. The co-infusion apparatus according to claim 13, wherein the apparatus performs a plunger pulling operation to introduce air into the syringe and merge the air with an air bubble inside the syringe thereby creating a layer of air until the layer has a volume represented by one or a few scale marks indicated on the syringe.

16. The co-infusion apparatus according to claim 5, wherein the medicine container held by the container holding section has its mouth positioned at a pivot center of the individual pivoting of the container holding section.

17. The co-infusion apparatus according to claim 6, wherein the medicine container held by the container holding section has its mouth positioned at a pivot center of the individual pivoting of the container holding section.

18. The co-infusion apparatus according to claim 7, wherein the medicine container held by the container holding section has its mouth positioned at a pivot center of the individual pivoting of the container holding section.

19. The co-infusion apparatus according to claim 5, further comprising a mechanism for moving the container holding section so that moving the container holding section eliminates or reduces a positional change of the mouth of the medicine container relative to the needle caused by the individual pivoting of the container holding section.
